(19) United States
(12) Patent Application Publication
(10) Pub. No.: US 2024/0414610 A1
(43) Pub. Date: Dec. 12, 2024

(54) First Node, Second Node and Methods Performed Thereby for Handling Migration of a Node

(71) Applicant: Telefonaktiebolaget LM Ericsson (publ), Stockholm (SE)

(72) Inventors: Marco Belleschi, Solna (SE); Filip Barac, Huddinge (SE)

(21) Appl. No.: 18/558,801

(22) PCT Filed: May 6, 2022
(86) PCT No.: PCT/SE2022/050443

§ 371 Date: Nov. 3, 2023

Related U.S. Application Data
(60) Provisional application No. 63/185,502, filed on May 7, 2021.

(51) Int. Cl. H04W 36/08; H04W 36/00; H04W 76/20

(52) U.S. Cl. CPC H04W 36/08; H04W 36/0033; H04W 36/0058; H04W 76/20

(57) ABSTRACT

A performed by a first node (111). The method is for handling migration of a node. The first node (111) operates in a communications network (100). The first node (111) sends (1003) an indication to a second node (112) comprised in the communications network (100). The indication indicates a context of a third node (113). The third node (113) is comprised in the communications network (100) and is to be migrated from the first node (111) to the second node (112). The context is for control of radio resource. A content of the indication is based on whether the migration of the third node (113) is to be partial or full. The sending (1003) of the indication is performed in response to a first indication received from the second node (112). The first indication requests the context of the third node (113) from the first node (111).

### TECHNICAL FIELD

The present disclosure relates generally to a first node, and methods performed thereby, for handling migration of a node. The present disclosure also relates generally to a second node and methods performed thereby for handling migration of the node.

### BACKGROUND

Nodes within a communications network may be network nodes, such as radio network nodes, e.g., Transmission Points (TP). The communications network may cover a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to a wireless device. The so-called 5G system, from a radio perspective started to be standardized in 3GPP, and the so-called New Radio (NR) is the name for the radio interface. NR architecture is being discussed in 3GPP. In the current concept, gNB denotes NR BS, where one NR BS may correspond to one or more transmission/reception points. The expression Uplink (UL) may be used for the transmission path in the opposite direction i.e., from the wireless device to the base station.

### Integrated Access and Backhaul Networks

3GPP has completed the integrated access and wireless access backhaul in NR (IAB) Rel-16 and is currently standardizing the IAB Rel-17.

### Protocol and Architecture Overview

The usage of short range mmWave spectrum in NR may be understood to create a need for densified deployment with multi-hop backhauling. However, optical fiber to every base station may be understood be too costly and sometimes not even possible, e.g., historical sites. The main IAB principle may be understood to be the use of wireless links for the backhaul, instead of fiber, to enable flexible and very dense deployment of cells without the need for densifying the transport network. Use case scenarios for IAB may include coverage extension, deployment of massive number of small cells and fixed wireless access (FWA), e.g., to residential/office buildings. The larger bandwidth available for NR in mmWave spectrum may provide opportunity for self-backhauling, without limiting the spectrum to be used for the access links. On top of that, the inherent multi-beam and Multiple Input Multiple Output (MIMO) support in NR may reduce cross-link interference between backhaul and access links allowing higher densification.

During the study item phase of the IAB work, a summary of the study item may be found in the technical report TR 38.874, it has been agreed to adopt a solution that may leverage the Central Unit (CU)/Distributed Unit (DU) split architecture of NR, where the IAB node may be hosting a DU part that may be controlled by a central unit. The IAB nodes may be also have a Mobile Termination (MT) part that they may be used to communicate with their parent nodes.

The specifications for IAB strive to reuse existing functions and interfaces defined in NR. In particular, MT, gNB-DU, gNB-CU, User Plane Function (UPF), Access and Mobility Management Function (AMF) and Session Management Functions (SMF) as well as the corresponding interfaces NR Uu, between MT and gNB, F1, NG, X2 and N4 may be used as baseline for the IAB architectures. Modifications or enhancements to these functions and interfaces for the support of IAB will be explained in the context of the architecture discussion. Additional functionality such as multi-hop forwarding may be included in the architecture discussion as it may be necessary for the understanding of IAB operation and since certain aspects may require standardization.

The Mobile-Termination (MT) function has been defined as a component of the IAB node. In the context of this study, MT may be referred to as a function residing on an IAB-node that may terminate the radio interface layers of the backhaul Uu interface toward the IAB-donor or other IAB-nodes. FIG. 1 is a schematic diagram showing a high-level architectural view of an IAB network. Particularly, FIG. 1 shows a reference diagram for IAB in standalone mode, which contains one IAB-donor 1 and multiple IAB-nodes 2. The IAB-donor 1 may be treated as a single logical node that may comprise a set of functions such as gNB-DU 3, gNB-CU-CP 4, gNB-CU-UP 5 and potentially other functions 6. In a deployment, the IAB-donor 1 may be split according to these functions, which may all be either collocated or non-collocated as allowed by 3GPP NG-Radio Access Network (RAN) architecture. The IAB-donor 1 may be connected to a Core Network (CN) 7. A UE 8 may gain access to the network via one of the IAB-nodes 2 to which the IAB-donor 1 may provide a wireless backhaul link. An IAB node may consist of a DU part, which may serve UEs 8 and possible other so-called child IAB nodes 9, and a Mobile Termination (MT) part, which may handle the backhaul link towards another IAB (DU) node or the IAB (DU) donor. IAB-related aspects may arise when such split is exercised. Also, some of the functions presently associated with the IAB-donor may eventually be moved outside of the donor in case it becomes evident that they do not perform IAB-specific tasks.

The Baseline User Plane (UP) and control plane protocol (CP) stacks for IAB are shown in FIG. 2 and FIG. 3, respectively. Particularly, FIG. 2 is a schematic diagram showing a Baseline UP Protocol stack for IAB in rel-16, in each of an IAB-donor-CU-UP 10, an IAB-donor-DU 11, a first IAB-node (IAB-node 1) 12, and a second IAB-node (IAB-node 2) 13. Each of the first IAB-node 12, and the second IAB-node 13 may have a DU 14 and an MT 15. The connections are depicted between the different protocols, in the different entities, either via a BH Radio Link Control (RLC) Channel 16, and/or an Intra-donor F1 channel 17 in FIG. 2. As shown in FIG. 2 and FIG. 3, the chosen protocol stacks may reuse the current CU-DU split specification in Rel-15, where the full user plane F1-U 18 General Packet Radio Service Tunneling Protocol User Plane (GTP-U) 19/User Datagram Protocol (UDP) 20/Internet Protocol (IP) 21) may be terminated at the IAB node 13, as a normal DU. A new protocol layer called Backhaul Adaptation Protocol (BAP) 22 has been introduced in the IAB nodes and the IAB donor, which may be used for routing of packets to the appropriate downstream/upstream node and also mapping the UE bearer data to the proper backhaul RLC channel, and also between ingress and egress backhaul Radio Link Control (RLC) 23 channels in intermediate IAB nodes, to satisfy the end-to-end Quality of Service (QOS) requirements of bearers. Therefore, the BAP layer may be in charge of handling the Backhaul (BH) RLC channel, e.g., to map an ingress BH RLC channel from a parent/child IAB node to an egress BH RLC channel in the link towards a child/parent IAB node. In particular, one BH RLC channel may convey end-user traffic for several Data Radio Bearers (DRBs) and for different UEs which may be connected to different IAB nodes in the network. In 3GPP, two possible configuration of BH RLC channel may be provided, i.e., a 1:1 mapping between BH RLC channel and a specific user's Data Radio Bearer (DRB), a N:1 bearer mapping, where N DRBs possibly associated to different UEs may be mapped to 1 BH RLC channel. The first case may be easily handled by the IAB node's scheduler since there may be understood to be a 1:1 mapping between the QoS requirements of the BH RLC channel and the QoS requirements of the associated DRB. However, this type of 1:1 configuration is not easily scalable in case an IAB node may be serving many UEs/DRBs. On the other hand, the N:1 configuration may be understood to be more flexible/scalable, but ensuring fairness across the various served BH RLC channels may be trickier, because the amount of DRBs/UEs served by a given BH RLC channel may be different from the amount of DRBs/UEs served by another BH RLC channel. FIG. 2 further depicts the Medium Access Control (MAC) 24, the Physical Layer (PHY) 25, Layer 1 (L1) 26 and Layer 2 (L2) 27 at the indicated entities, and their interconnections.

FIG. 3 is a schematic diagram showing a Baseline CP Protocol stack for IAB in rel-16. As shown in FIG. 3, the full control plane F1-C 31, F1-AP 32/Stream Control Transmission Protocol (SCTP) 33/IP 34, may be also terminated at the IAB node 13, as a normal DU. In the above cases, Network Domain Security (NDS) may be employed to protect both UP and CP traffic, IPsec in the case of UP, and Datagram Transport Layer Security (DTLS) in the case of CP. IPsec may also be used for the CP protection instead of DTLS, in this case no DTLS layer would be used.

### BAP Entities

On the IAB-node, the BAP sublayer may contain one BAP entity at the MT function and a separate co-located BAP entity at the DU function. On the IAB-donor-DU, the BAP sublayer may contain only one BAP entity. Each BAP entity may have a transmitting part and a receiving part. The transmitting part of the BAP entity may have a corresponding receiving part of a BAP entity at the IAB-node or IAB-donor-DU across the backhaul link.

FIG. 4 is a schematic diagram showing one example of the functional view of the BAP sublayer. This functional view should not restrict implementation. The figure is based on the radio interface protocol architecture defined in TS 38.300, v. 16.5.0. In the example of FIG. 4, the receiving part on the BAP entity 41 delivers BAP Protocol Data Units (PDUs) to the transmitting part 42 on the collocated BAP entity. Alternatively, the receiving part 41 may deliver BAP Service Data Units (SDUs) to the collocated transmitting part 42. When passing BAP SDUs, the receiving part 41 may remove 43 the BAP header, and the transmitting part 42 may add 44 the BAP header with the same BAP routing Identity or Identifier (ID) as carried on the BAP PDU header prior to removal. Passing BAP SDUs in this manner may therefore be functionally equivalent to passing BAP PDUs, in implementation.

### Services Provided to Upper Layers

The following services may be provided by the BAP sublayer to upper layers: data transfer.

Services Expected from Lower Layers

A BAP sublayer may expect the following services from lower layers per RLC entity, for a detailed description see TS 38.322: acknowledged data transfer service, and unacknowledged data transfer service.

### Functions

The BAP sublayer may support the following functions: data transfer, determination of BAP destination and path for packets from upper layers 45, determination of egress BH RLC channels for packets routed to next hop, routing of packets to next hop 46, differentiating traffic to be delivered to upper layers from traffic to be delivered to egress link, and flow control feedback and polling signalling.

Therefore, the BAP layer may be understood to be fundamental to determine how to route a received packet. For the downstream that may be understood to imply determining whether the packet has reached its final destination, in which case the packet may be transmitted to UEs that are connected to this IAB node as access node, or to forward it to another IAB node in the right path. In the first case, the BAP layer may pass the packet to higher layers in the IAB node which may be in charge of mapping the packet to the various QoS flows and hence DRBs which may be included in the packet. In the second case 20 instead, the BAP layer may determine 47 the proper egress BH RLC channel on the basis of the BAP destination, path IDs and ingress BH RLC channel. The same as the above may apply also to the upstream, with the only difference that the final destination may be always one specific donor DU/CU.

In order to achieve the above tasks, the BAP layer of the IAB node may have to be configured with a routing table mapping ingress RLC channels 48 to egress RLC channels 49, which may be different depending on the specific BAP destination and path of the packet. Hence, the BAP destination and path ID may be included in the header of the BAP packet so that the BAP layer may determine 50 where to forward the packet.

Additionally, the BAP layer may have an important role in the hop-by-hop flow control. In particular, a child node may inform the parent node about possible congestions experienced locally at the child node, so that the parent node may throttle the traffic towards the child node. The parent node may also use the BAP layer to inform the child node in case of Radio Link Failure (RLF) issues experienced by the parent, so that the child may possibly re-establish its connection to another parent node. As depicted in FIG. 4, a Radio Interface (Uu) 51 may connect the egress BH RLC channel 49 of the transmitting part 42 with the ingress CH RLC channel 48 of the receiving part 41.

### Topology Adaptation Scenarios for Baseline Architecture

Topology adaptation in IAB networks may be needed for various reasons, e.g., changes in the radio conditions, changes to the load under the serving CU, radio link failures, etc. The consequence of an IAB topology adaptation may be that an IAB node may be migrated, that is, handed-over, to a new parent, which may be controlled by the same or different CU, or that some traffic currently served by such IAB node may be offloaded via a new route, which may be controlled by the same or different CU. If the new parent of the IAB node is under the same CU or a different CU, the migration may be understood to be intra-donor and inter-donor one, respectively, herein also referred to as the intra-CU and inter-CU migration.

FIG. 5 is a schematic diagram showing an example of some possible IAB-node migration scenarios, that is, of topology adaptation, cases listed in the order of complexity.

Intra-CU Case (A): In this case, the IAB-node (e) 52 along with it serving UEs, UEc 53, UEd 54 and UEe 55, may be moved to a new parent node, IAB-node (b) 56, under the same donor-DU (1) 57. The successful intra-donor DU migration may require establishing UE context setup for the IAB-node (e) MT 58 in the DU 59 of the new parent node, IAB-node (b) 56, updating routing tables of IAB nodes along the path to IAB-node (e) 52 and allocating resources on the new path. The IP address for IAB-node (e) 52 may not change, while the F1-U tunnel/connection between donor-CU (1) 60 and IAB-node (e) DU 61 may be redirected through IAB-node (b) 56.

Intra-CU Case (B): The procedural requirements/complexity of this case may be understood to be the same as that of Case (A). Also, since the new IAB-donor DU, that is, DU2 62, is connected to the same L2 network 63, the IAB-node (e) 61 may use the same IP address under the new donor DU. However, the new donor DU, that is, DU2 62, may need to inform the network using IAB-node (e) L2 address in order to get/keep the same IP address for IAB-node (e) 52 by employing some mechanism such as Address Resolution Protocol (ARP).

Intra-CU Case (C): This case may be understood to be more complex than Case (A) as it may also need allocation of new IP address for IAB-node (e) 52. In case, IPsec may be used for securing the F1-U tunnel/connection between the Donor-CU (1) 60 and IAB-node (e) DU 61, then it may be possible to use existing IP address along the path segment between the Donor-CU (1) 60 and Security Gateway (SeGW), and new IP address for the IPsec tunnel between SeGW and IAB-node (e) DU 61.

Inter-CU Case (D): This may be understood to be the most complicated case in terms of procedural requirements, and may need new specification procedures, such as enhancement of Radio Resource Control (RRC), F1AP, XnAP, Ng signaling, that are beyond the scope of 3GPP Rel-16.

3GPP Rel-16 specifications only consider procedures for intra-CU migration. Inter-CU migration requires new signalling procedures between source and target CU 64 in order to migrate the IAB node contexts and its traffic to the target CU, such that the IAB node operations may continue in the target CU 64 and the QoS is not degraded. Inter-CU migration is expected to be specified in the context of 3GPP Rel17.

### Inter-CU Migration in Rel17

As mentioned above, 3GPP Rel-16 has standardized only intra-CU topology adaptation procedure. Considering that inter-CU migration will be an important feature of IAB Rel-17 WI, enhancements to existing procedure may be required for reducing service interruption, due to IAB-node migration, and signaling load.

Some use cases for inter-donor topology adaptation, a.k.a. inter-CU migration, may be, as one option, inter-donor load balancing. One possible scenario may be that a link between an IAB node and its parent becomes congested. In this case, the traffic of an entire network branch, below and including the said IAB node, herein referred to as the top-level IAB node, may be redirected to reach the top-level node via another route. If the new route for the offloaded traffic includes traversing the network under another donor before reaching the top-level node, the scenario may be understood to be an inter-donor routing one. The offloaded traffic may include both the traffic terminated at the top-level IAB node and its served UEs, or the traffic traversing the top-level IAB node, and terminated at its descendant IAB nodes and UEs. In this case, the MT of the top-level IAB node, that is, top-level IAB-MT, may establish an RRC connection to another donor, thus releasing its RRC connection to the old donor, and the traffic towards this node and its descendant devices may now be sent via the new donor. Another use case for inter-donor topology adaptation, a.k.a. inter-CU migration, may be inter-donor RLF recovery, where an IAB node experiencing an RLF on its parent link may attempt RRC reestablishment towards a new parent under another donor, this node may also be referred to as the top-level IAB node. According to 3GPP agreements, if the descendant IAB nodes and UEs of the top-level node “follow” to the new donor, the parent-child relations may be retained after the top-level node connects to another donor.

The above cases assume that the top-level node's IAB-MT may connect to only one donor at a time. However, Rel17 work is expected to also consider the case where the top-level IAB-MT may simultaneously connect to two donors, in which case the following two considerations may be made. For load balancing, the traffic reaching the top-level IAB node via one leg may be offloaded to reach the top-level IAB node, and, potentially, its descendant nodes, via the other leg that the node may have established to another donor. For RLF recovery, the traffic reaching the top-level IAB node via the broken leg may be redirected to reach the node via the “good” leg, towards the other donor.

With respect to inter-donor topology adaptation, the 3GPP Rel17 specifications may allow two alternatives. The first alternative may be a proxy-based solution or partial migration, assuming that top-level IAB-MT may be capable of connecting to only one donor at a time, the top-level IAB-MT may migrate to a new donor, while the F1 and RRC connections of its collocated IAB-DU and all the descendant IAB-MTs, IAB-DUs and UEs may remain anchored at the old donor. The proxy-based solution may also be applicable in the case when top-level IAB-MT may be simultaneously connected to two donors. In this case, some or all of the traffic traversing/terminating at the top-level node may be offloaded via the leg towards the ‘other’ donor. In this case after the migration, the egress BH RLC channel, for upstream traffic, and the ingress BH RLC channel, for downstream traffic, of the top level IAB node may be configured and controlled by the target donor, while all the BH RLC channels between the top-level IAB node and its descendant IAB nodes/UEs may be retained by the source CU. Similarly, the routing tables that allow communication between the top level node and the target CU may be configured and controlled by the target CU, while the routing tables that allow communication between the top level node and its descendant IAB nodes/UEs may be configured and controlled by the source CU.

The second alternative may be a full migration-based solution, where all the F1 and RRC connections of the top-level node and all its descendant devices and UEs may be migrated to the new donor.

### Details and an Example of Proxy-Based Solution for Inter-CU Migration

One drawback of the full migration-based solution for inter-CU migration is that a new F1 connection may be set up from IAB-node E to the new CU, that is, CU(2) 64, and the old F1 connection to the old CU, that is, CU(1) 60 may be released.

Releasing and relocating the F1 connection may be understood to impact all UEs, that is, UEc 53, UEd 54, and UEe 55, and any descendant IAB nodes, and their served UEs, by causing service interruption for the UEs and IAB nodes served by the top-level IAB node, that is, IAB-node E 61, since these UEs may need to re-establish their connection or to perform handover operation, even if they remain under the same IAB node, as 3GPP security principles mandate to perform key refresh whenever the serving CU/gNB may be changed, e.g., at handover or reestablishment, that is, RRC reconfiguration with reconfigurationWithSync may have to be sent to each UE.

Releasing and relocating the F1 connection may be understood to impact all UEs, that is, UEc 53, UEd 54, and UEe 55, and any descendant IAB nodes, and their served UEs, also by causing a signaling storm, since a large number of UEs, IAB-MTs and IAB-DUs may have to perform re-establishment or handover at the same time.

In addition, it may be preferred that any reconfiguration of the descendant nodes of the top-level node, in embodiments herein, the term top-level node may also be used, is avoided. This means that the descendant nodes may need to preferably be unaware of the fact that the traffic is proxied via CU2.

To address the above problems, a proxy-based mechanism has been proposed where the inter-CU migration may be performed without handing over the UEs or IAB nodes directly or indirectly being served by the top-level IAB node, thereby making the handover of the directly and indirectly served UEs transparent to the target CU. In particular, only the RRC connection of the top-level IAB node may be migrated to the target CU, while the CU-side termination of its F1 connection as well as the CU-side terminations of the F1 and RRC connections of its directly and indirectly served IAB nodes and UEs may be kept at the source CU—in this case, the target CU may serve as the proxy for these F1 and RRC connections that may be kept at the source CU. Hence in this case, the target CU may just need to ensure that the ancestor node of the top-level IAB node are properly configured to handle the traffic from the top-level node to the target donor, and from the target donor to the top-level node. Meanwhile, the configuration of the descendant IAB node of the said top-level node may still be under the control of the source donor. Hence, in this case, the target donor may not need to know the network topology and the QoS requirements or the configuration of the descendant IAB nodes and UEs.

FIG. 6 is a schematic diagram showing an example of a signal flow before IAB-node 3 migration. The signalling connections when the F1 connections may be maintained in the CU-1. Two different CUs are depicted in FIG. 6: CU-1 60 and CU-2 61. Three different IAB nodes, IAB node 1 62, IAB node 3 63 and IAB node 4 64 have respective MT terminations 65, 66, 67 in RRC connected mode with CU-1 60, and respective DU terminations 68, 69, 70 having respective F1 connections 71, 72, 73 to CU-1 60 for, respectively, IAB node 3 63, IAB node 4 64 and UEe 74. The DU termination of the donor node 1, DU-1 75 has an F1 connection 76 to the CU-1 60 for IAB node 1 62.

Another IAB node, IAB node 2 77, has an MT terminations 78 in RRC connected mode with CU-2 61, and a DU terminations 79 having an F1 connections 80 to CU-2 61 for UEd 81. UEa 82, UEb 83, UEc 84, served by IAB node 4 63 and UEe 74 are all connected to CU-1 60.

FIG. 7 is a schematic diagram showing an example of a signal flow after IAB-node 3 63 migration, in which it is assumed that the IAB node 3 63 experienced an RLF in the link with IAB node 1 62. FIG. 7 highlights how the F1-U may be tunnelled over the Xn 85 and then transparently forwarded to the IAB donor-DU-2 86 after the IAB node is migrated to the target donor CU that is, CU2 62.

In particular, from a configuration perspective, the proxy-based solution may be realized by, in one aspect, configuring the top level IAB node, that is, IAB3 63, with a mapping table, that may map BAP routing ID/BH RLC channels/BAP addresses assigned, via the source CU 60, by the target CU 61 into BAP routing ID/BH RLC channels/BAP addresses configured by the source CU 60. In a second aspect, the proxy-based solution may be realized by enabling the top level IAB node to overwrite the BAP header fields e.g. Routing ID, with the BAP Routing ID needed for BH communications with its descendant IAB nodes for downstream traffic, and ancestor IAB nodes for upstream traffic.

### Re-Establishment and Context Fetch

In case of RLF in the serving cell, the UE may try to re-establish the connection in one of the neighbor cells, e.g., upon fulfilling the cell selection criteria. FIG. 8 is a schematic diagram illustrating an example of a Re-establishment procedure, according to FIG. 9.2.3.3-1 of TS 38.300, v. 16.5.0. For example, in the case of FIG. 8, the IAB node may have experienced an RLF in the link towards the IAB node 1, and reselect for reestablishment a cell hosted by the IAB node 2 which may be controlled by a target CU, that is, CU2, which may be different from the last serving CU, that is, CU1. The selected neighbor cell and CU may not be obviously aware of the related UE context and hence before allowing the reestablishment may need to acquire the UE context from the cell in which the failure was experienced. This may be possible because the UE in the RRCReestablishmentRequest message may include the physical cell ID of the cell in which the RLF occurred, so that the cell selected for reestablishment may identify the last serving gNB and retrieve the UE context accordingly, following the retrieve UE Context Request/Response procedure. This procedure is described in TS 38.300 section 9.2.3.3, v. 16.5.0 described below:

A UE 87 in RRC_CONNECTED may initiate the re-establishment procedure to continue the RRC connection when a failure condition occurs, e.g. radio link failure, reconfiguration failure, integrity check failure . . . . FIG. 8 describes the re-establishment procedure started by the UE 87. In Step 1, the UE 87 re-establishes the connection, providing the UE Identity, e.g., Physical Cell Identity (PCI)+Cell Radio Network Temporary Identifier (C-RNTI) to the gNB 88 where the trigger for the re-establishment occurred. In Step 2, if the UE Context is not locally available, the gNB 88 may request the last serving gNB 89 to provide UE Context data. In Step 3, the last serving gNB 89 may provide UE context data. In Step 4/4a, the gNB 88 may continue the re-establishment of the RRC connection. The message may be sent on SRB1. In Step 5/5a, the gNB 88 may perform the reconfiguration to re-establish SRB2 and DRBs when the re-establishment procedure is ongoing. In Step 6/7, if loss of user data buffered in the last serving gNB is to be prevented, the gNB provides forwarding addresses, and the last serving gNB 89 provides the SN status to the gNB 88. In Step 8/9, the gNB 88 may perform path switch via an AMF 90. In Step 10, the gNB 88 may trigger the release of the UE resources at the last serving gNB 89.

The IAB-MT in StandAlone (SA) mode may follow the same re-establishment procedure as described for the UE. After the backhaul may have been established, the re-establishment procedure of the IAB-MT may be part of the intra-CU backhaul RLF recovery procedure for IAB-nodes defined in TS 38.401, v. 16.5.0. Modifications to the configuration of BAP sublayer and higher protocol layers above the BAP sublayer may be as described in TS 38.401, v. 16.5.0.

The mentioned UE Context Request/Response procedure may be used when the UE may initiate a resume procedure to transit from RRC_Inactive to RRC_Connected, that is, the gNB to which the UE transmitted the RRCResumeRequest may transmit the Retrieve UE Context Request to the last serving gNB which in turn may reply with a Retrieve UE Context Response. The same procedure may be also applicable to an IAB node initiating a resume procedure to a cell controlled by a different CU than the last serving cell.

Existing methods for migrating nodes in a multi-hop integrated access and backhaul (IAB) deployment may lead to waste of radio resources, increased latency, waste of processing resources, and waste of energy resources.

### SUMMARY

As part of the development of embodiments herein, one or more challenges with the existing technology will first be identified and discussed.

The existing UE context retrieval procedure that is, the Retrieve UE Context procedure defined in TS 38.423 v16.5.0, may be applicable also to the case in which an IAB node may be attempting an RRC reestablishment or a resume to a cell, e.g., to another parent IAB node, controlled by a CU different, say target CU, than the last serving CU, say source CU. However, from the perspective of the target CU there may be understood to be a significant difference between accepting the reestablishment of an IAB node and the reestablishment of an ordinary UE. In fact, an IAB node may serve directly or indirectly several other IAB nodes, that is, descendant IAB nodes, and UEs, which may obviously have a different impact in the target CU in terms of capacity and resource utilization compared with an ordinary reestablishment of a single UE.

Additionally, unlike the ordinary RRC reestablishment of a UE, the reestablishment of an IAB node may, as described in Section 2.1.1.4, imply either the complete migration, that is, “full migration”, of such IAB node and its descendant IAB nodes and UEs, or a partial migration, as in the case of the so-called “proxy-based migration” in which only the top level IAB node may migrate to a target CU, while its F1 connection, as well as the context of the descendant IAB nodes and UEs may be retained by the source CU.

Should the legacy UE context retrieval procedure be reused for IAB inter-donor migration, the two migration options, proxy-based and full migration-based, may require different enhancements of the legacy UE context retrieval procedure, both in terms of signaling procedures between target and source CU and in the decisions taken at source and target CU. However, the current reestablishment procedure does not consider that these two different types of migrations are possible, and this makes in practice the legacy UE context retrieval procedure not fully tailored to inter-CU IAB migration scenarios.

According to the foregoing, it is an object of embodiments herein to improve the handling of migration of a node in a communications network.

According to a first aspect of embodiments herein, the object is achieved by a method, performed by a first node. The method is for handling migration of a node. The first node operates in the communications network. The first node sends an indication to the second node comprised in the communications network. The indication indicates a context of a third node, comprised in the communications network, to be migrated from the first node to the second node. The context is for control of radio resource. A content of the indication is based on whether the migration of the third node is to be partial or full. The sending of the indication is performed in response to a first indication received from the second node. The first indication requests the context of the third node from the first node.

According to a second aspect of embodiments herein, the object is achieved by a method, performed by the second node. The method is for handling migration of the node. The second node operates in the communications network. The second node receives the indication from the first node comprised in the communications network. The indication indicates the context of the third node, comprised in the communications network. The third node is to be migrated from the first node to the second node. The context is for control of radio resource. The content of the indication is based on whether the migration of the third node is to be partial or full. The receiving of the indication is performed in response to the first indication sent by the second node. As stated earlier, the first indication requests the context of the third node from the first node.

According to a third aspect of embodiments herein, the object is achieved by the first node, for handling migration of the node. The first node is configured to operate in the communications network. The first node is further configured to send the indication to the second node configured to be comprised in the communications network. The indication is configured to indicate the context of the third node. The third node is configured to be comprised in the communications network and configured to be migrated from the first node to the second node. The context is configured to be for control of radio resource. The content of the indication is configured to be based on whether the migration of the third node is to be partial or full. The sending of the indication is configured to be performed in response to the first indication configured to be received from the second node. The first indication is configured to request the context of the third node from the first node.

According to a fourth aspect of embodiments herein, the object is achieved by the second node, for handling migration of the node. The second node is configured to operate in the communications network. The second node is further configured to receive the indication from the first node configured to be comprised in the communications network. The indication is configured to indicate the context of the third node, configured to be comprised in the communications network, to be migrated from the first node to the second node. The context is configured to be for control of radio resource. The content of the indication is configured to be based on whether the migration of the third node is to be partial or full. The receiving of the indication is configured to be performed in response to the first indication configured to be sent by the second node. The first indication is configured to request the context of the third node from the first node.

By the first node sending the indication to the second node, wherein the content of the indication is based on whether the migration of the third node is to be partial or full, the first node may have the possibility to exchange information related to the context of a migrating IAB node such as the third node, say top level IAB node, and optionally of the descendant IAB nodes and UEs served by such migrating IAB node, and e.g., the UEs served by its descendant IAB nodes, and the information about the necessary resources to serve the traffic to/from these devices, thereby allowing the migrating top-level node, and its descendant IAB nodes/UEs, to continue communications with the network.

As another advantage, the first node and the second node, e.g., the source CU and target CU, may be enabled to exchange information on the type of migration needed, that is, full migration or partial migration, and hence to select the preferred migration type. Such information may enable the second node to decide if it may accept or not the third node and all the traffic of the descendants and UEs that it and its descendants may be serving.

This may be understood to improve the performance of the communications network by making migration more flexible, and enabling the continue to provide service to some nodes in the communications network in view of the changing circumstances, without disrupting service to other nodes in the communications network that may not have been directly affected by such changes. Tailoring the migration of the nodes to the conditions of the other nodes involved, such as load and service requirements, may enable to secure the provision of services in the communications network with e.g., a required level of quality.

By the sending of the indication being performed in response to the first indication received from the second node, the first indication requesting the context of the third node, the benefits of the migration may be performed, even when the third node to be migrated may have lost a connection with the first node, e.g., due to an RLF with a parent node, served by the first node, and may not be capable to request the migration through the first node.

### BRIEF DESCRIPTION OF THE DRAWINGS

Examples of embodiments herein are described in more detail with reference to the accompanying drawings, and according to the following description.

FIG. 1 is a schematic diagram illustrating an example of a reference diagram for IAB-architectures from 3GPP TR 38.300 v16.5.0, according to existing methods.

FIG. 2 is a schematic diagram illustrating an example of a Baseline User Plane (UP) Protocol stack for IAB in rel-16, according to existing methods.

FIG. 3 is a schematic diagram illustrating an example of a Baseline control plane (CP) Protocol stack for IAB in rel-16, according to existing methods.

FIG. 4 is a schematic diagram illustrating an example of a functional view of the BAP sublayer, according to existing methods.

FIG. 5 is a schematic diagram illustrating an example of different possible scenarios for IAB topology adaptation, according to existing methods.

FIG. 6 is a schematic diagram illustrating an example of a signal flow before IAB-node 3 migration, according to existing methods.

FIG. 7 is a schematic diagram illustrating an example of a signal flow after IAB-node 3 migration, according to existing methods.

FIG. 8 is a schematic diagram illustrating an example of a Re-establishment procedure, according to FIG. 9.2.3.3-1 of TS 38.300, v. 16.5.0.

FIG. 9 is a schematic diagram illustrating a communications network, according to embodiments herein.

FIG. 10 depicts a flowchart of a method in a first node, according to embodiments herein.

FIG. 11 depicts a flowchart of a method in a second node, according to embodiments herein.

FIG. 12 is a schematic block diagram illustrating two non-limiting examples, a) and b), of a first node, according to embodiments herein.

FIG. 13 is a schematic block diagram illustrating two non-limiting examples, a) and b), of a second node, according to embodiments herein.

FIG. 14 is a schematic block diagram illustrating a telecommunication network connected via an intermediate network to a host computer, according to embodiments herein.

FIG. 15 is a generalized block diagram of a host computer communicating via a base station with a user equipment over a partially wireless connection, according to embodiments herein.

FIG. 16 is a flowchart depicting embodiments of a method in a communications system including a host computer, a base station and a user equipment, according to embodiments herein.

FIG. 17 is a flowchart depicting embodiments of a method in a communications system including a host computer, a base station and a user equipment, according to embodiments herein.

FIG. 18 is a flowchart depicting embodiments of a method in a communications system including a host computer, a base station and a user equipment, according to embodiments herein.

FIG. 19 is a flowchart depicting embodiments of a method in a communications system including a host computer, a base station and a user equipment, according to embodiments herein.

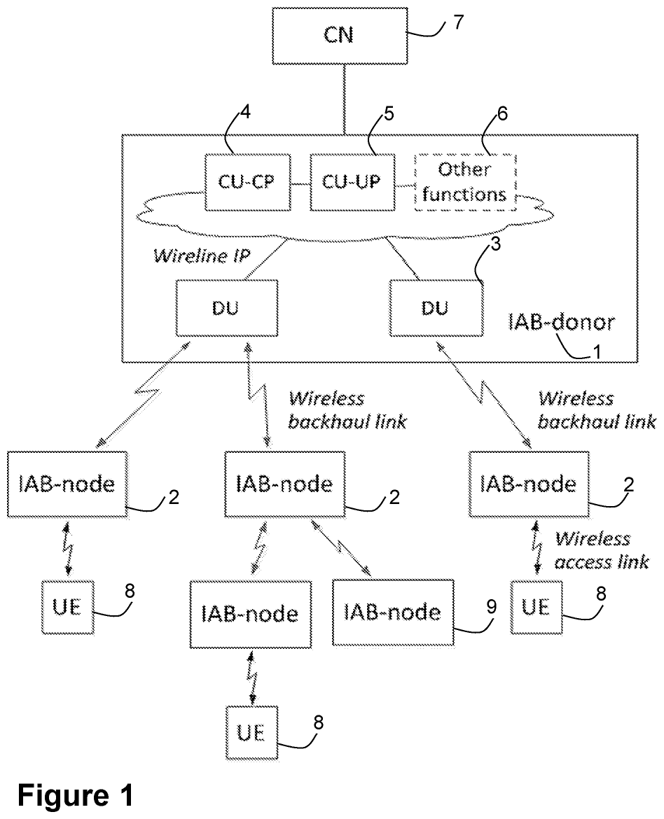

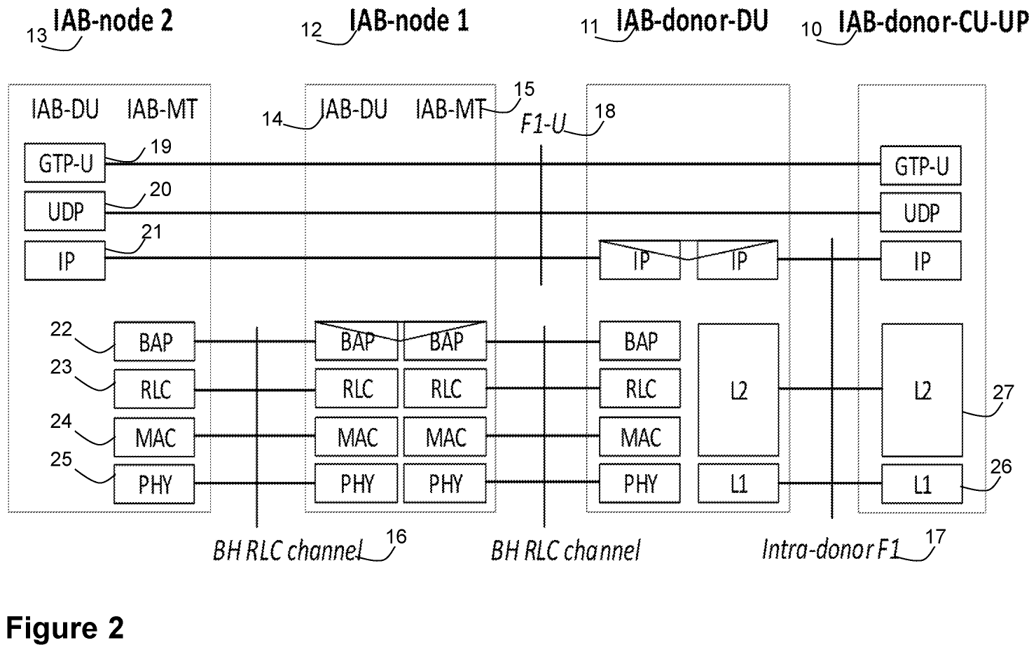

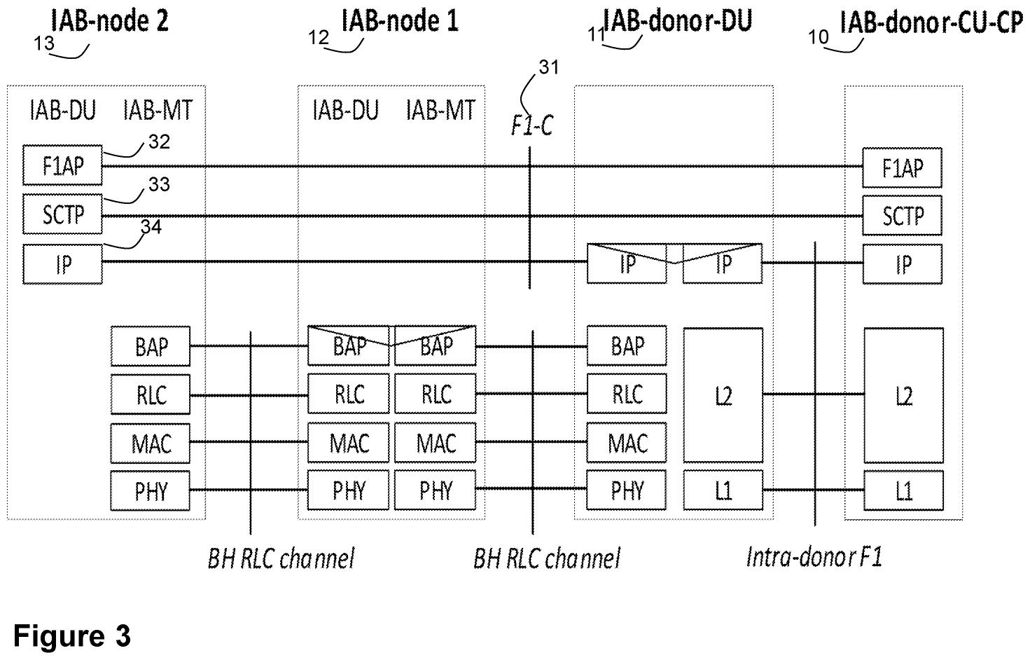

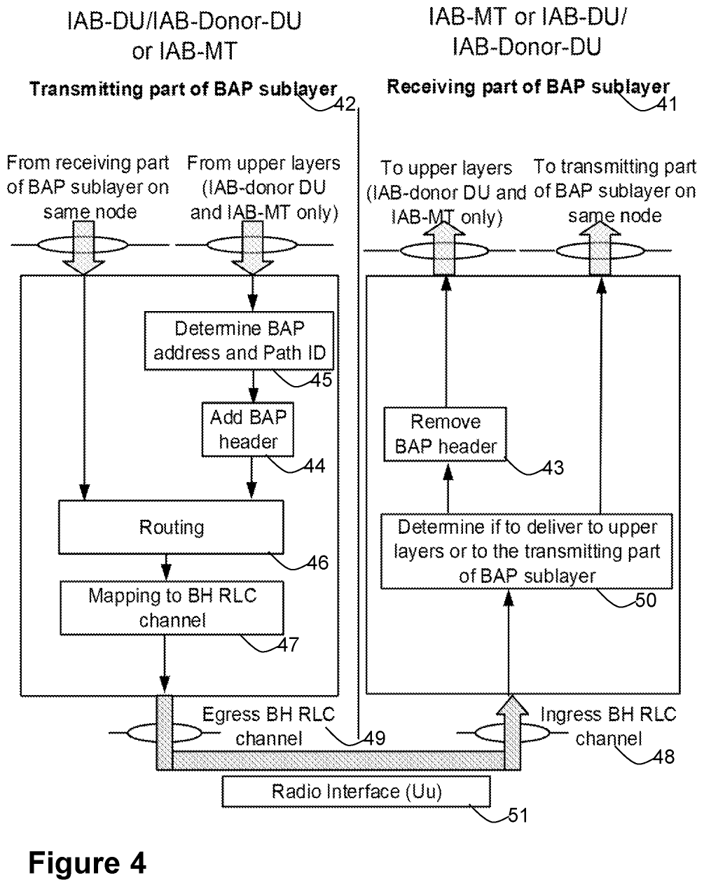

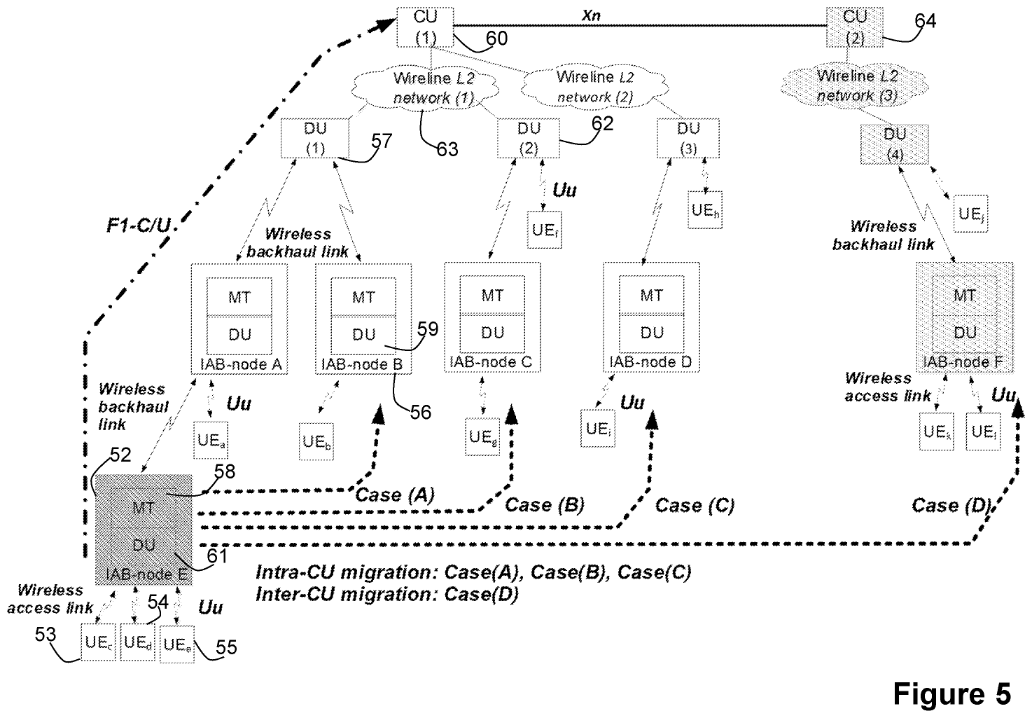

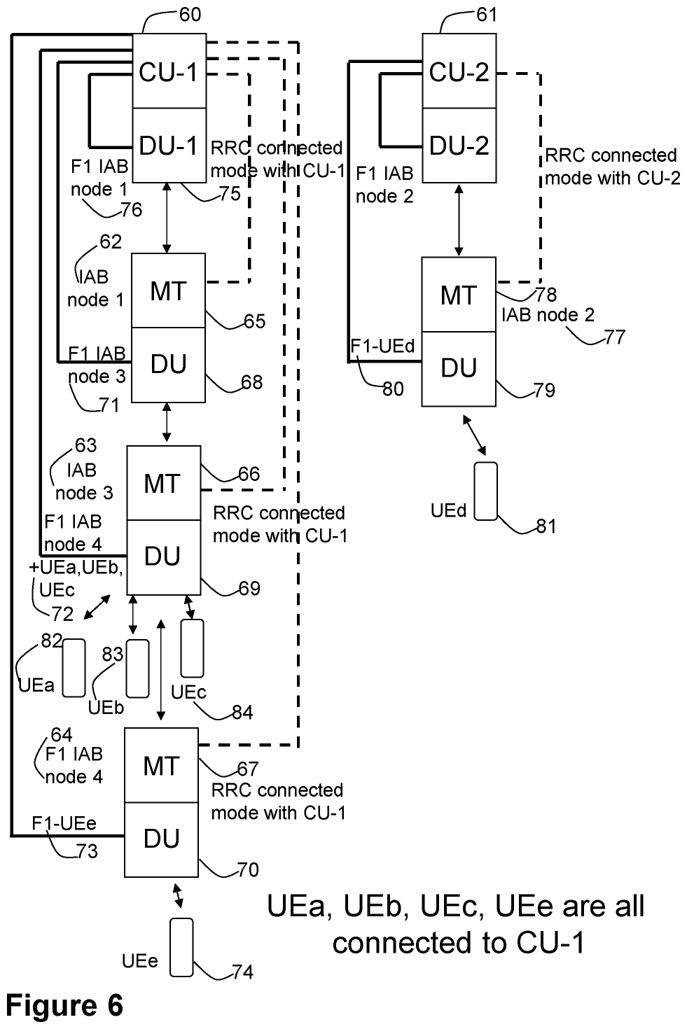

### DETAILED DESCRIPTION

Certain aspects of the present disclosure and their embodiments may provide solutions to the challenges discussed in the Summary section or other challenges. There are, proposed herein, various embodiments which address one or more of the issues disclosed herein.

As a brief overview, embodiments herein may be understood to relate to methods for IAB Context Retrieval at IAB inter-CU partial or full migration.

More particularly, embodiments herein may provide methods for an IAB context retrieval, wherein the associated signalling procedures may allow the source CU, which may be the last serving CU for the concerned top level IAB node, to indicate to the target CU, which may be the CU to which the top level IAB node may be attempting a reestablishment or a resume, the context of the concerned IAB node and optionally, e.g., in case of full migration, the contexts of the descendant IAB nodes and UEs, and wherein such signalling procedure may also include information on whether a full migration of the top level and its descendant IAB nodes/UEs or conversely a “proxy based solution” may be requested by the source to the target. The source CU may be understood to be an old CU and the target CU may be understood to be a new CU. The proxy based solution may be understood to be a partial migration.

Embodiments herein may also provide methods for the target CU to determine whether the migration requested by the source as part of the UE context retrieval may be performed or not. Methods for the target CU to acknowledge to the source CU the said migration may also be considered, as well as methods for the target CU to indicate the preferred migration option, that is, full migration or “proxy-based solution”.

In general, embodiments herein may therefore be understood to be related to IAB inter-donor topology adaptation, RLF recovery, and/or RRC reestablishment.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

### General

The term “descendant node” may refer to both the child node and the child of the child and so on, that is, all the IAB nodes that may be served directly or indirectly by a top level IAB node. Similarly, the term “descendant UE” may refer to any UE served directly by the top level IAB node or indirectly by the top level node via one or more descendant nodes.

The term “ancestor node” may refer to both the parent node and the parent of the parent and so on, including the donor node.

The terms “CU_1”, “source donor” and “old donor” are used interchangeably.

The terms “CU_2”, “target donor” and “new donor” are used interchangeably.

The terms proxy-based alternative/partial migration are used interchangeably.

Embodiments herein may apply to both the proxy-based alternative/partial migration and the full migration-based alternative, described in the Background Section entitled “Inter-CU migration in Rel17”.

The terms “migrating IAB node” and “top-level IAB node” are used interchangeably, and in the context of embodiments herein, may refer to the IAB node whose IAB-MT may transmit an RRCReestablishmentRequest or RRCResumeRequest to a target donor CU.

The term “migration” in the context of embodiments herein may be unambiguously used to represent the scenario in which a top-level/migrating IAB-MT may attempt a reestablishment, e.g., as a consequence of an experienced RLF, or a connection resume to a cell hosted by an IAB node or donor DU, controlled by a CU, that is, target CU, different than the last serving CU, that is, source CU. Hence, in the context of embodiments herein, once the migration is executed: a) the contexts of the top-level IAB node, of its descendant IAB nodes/UEs as well as their F1 and RRC connections may be moved to the target, corresponding to full migration, or b) the IAB-MT of the top level IAB node may migrate to the target CU, that is, the RRC context of this top level IAB node migrated to the target CU, while its F1 connection as well as the F1 and RRC connections of the descendant IAB nodes/UEs may remain anchored at the old donor, corresponding to partial migration.

Although embodiments herein may be presented on the scenario where the top-level IAB-MT may be connected only to one donor at a time, it may be understood to equally apply to the scenarios where the top-level IAB-MT may simultaneously connect to two donors

Embodiments herein may apply also to the scenario where top-level IAB-MT may be served by two gNBs, out of which one may be an IAB donor and the other one may be a legacy gNB, whereas either of the two serving nodes may be a master or a secondary node for the IAB-MT of the top-level node.

The terms “RRC/F1 connections of descendant devices” may be understood to refer to the RRC connections of descendant IAB-MTs and UEs with the donor, source donor in this case, and the F1 connections of the top-level IAB-DU and IAB-DUs of descendant IAB nodes of the top-level IAB node.

The signalling described in embodiments herein may be enabled by reusing existing procedures or it may be enabled by defining new dedicated procedures. For example, the UE Context Retrieve Acknowledgment may be newly defined for the purpose of the embodiments herein, while UE Context Retrieve Request may be as already specified in TS 38.423, v. 16.5.0 but, for the purpose of embodiments herein it may need to be enhanced. In general, the messages “UE Context Retrieve Request”, “UE Context Retrieve Response” “UE Context Retrieve Acknowledgment” may be assumed to be used to retrieve the context(s) of the top level IAB node and, optionally in case of full migration, of the top-level IAB-DU, of the of the descendant IAB nodes and UEs. However, other type of messages may be used to convey this information over the Xn interface.

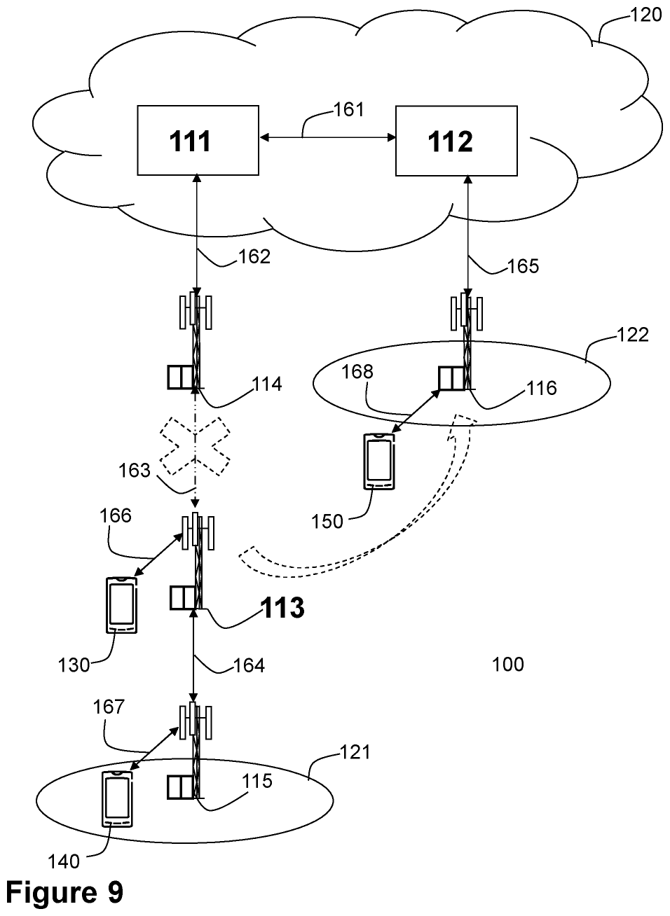

FIG. 9 depicts seven non-limiting examples of a communications network 100, which may be a wireless communications network, sometimes also referred to as a wireless communications system, cellular radio system, or cellular network, in which embodiments herein may be implemented. The communications network 100 may be a 5G system, 5G network, NR-U or Next Gen System or network, Long-Term Evolution (LTE) system, or a combination of both. The communications network 100 may be, or may support, a younger system than a 5G system. The communications network 100 may support technologies such as, particularly, LTE-Advanced/LTE-Advanced Pro, e.g., LTE Frequency Division Duplex (FDD), LTE Time Division Duplex (TDD), LTE Half-Duplex Frequency Division Duplex (HD-FDD), and/or LTE operating in an unlicensed band. The communications network 100 may support yet other technologies such as, for example, License-Assisted Access (LAA), Narrow Band Internet of Things (NB-IoT), Machine Type Communication (MTC), MulteFire, Wideband Code Division Multiplexing Access (WCDMA), Universal Terrestrial Radio Access (UTRA) TDD, Global System for Mobile communications (GSM) network, Enhanced Data for GSM Evolution (EDGE) network, GSM/EDGE Radio Access Network (GERAN) network, Ultra-Mobile Broadband (UMB), network comprising of any combination of Radio Access Technologies (RATs) such as e.g., Multi-Standard Radio (MSR) base stations, multi-RAT base stations etc., any 3rd Generation Partnership Project (3GPP) cellular network, WiFi networks, Worldwide Interoperability for Microwave Access (WiMax). In particular embodiments, the communications network 100 may be an Integrated Access and Backhaul (IAB) network. Thus, although terminology from 5G/NR and LTE may be used in this disclosure to exemplify embodiments herein, this should not be seen as limiting the scope of the embodiments herein to only the aforementioned systems.

The communications network 100 comprises a plurality of nodes, whereof a first node 111, a second node 112, a third node 113, one or more fourth nodes 114, one or more fifth nodes 115, and one or more sixth nodes 116 are depicted in the non-limiting examples of FIG. 9. In FIG. 9, the one or more fourth nodes 114 and the one or more fifth nodes 115 are respectively represented with a single node to simplify the Figure.

Any of the first node 111, the second node 112, the third node 113, the one or more fourth nodes 114, the one or more fifth nodes 115 and the one or more sixth nodes 116 may be a network node.

In particular embodiments, any of the first node 111, the second node 112, the third node 113, the one or more fourth nodes 114, the one or more fifth nodes 115 and the one or more sixth nodes 116 may be a radio network node, such as a radio base station, base station or a transmission point, or any other network node with similar features capable of serving a user equipment, such as a wireless device or a machine type communication device, in the communications network 100. For example, any of the first node 111, the second node 112, the third node 113, the one or more fourth nodes 114, the one or more fifth nodes 115 and the one or more sixth nodes 116 may be a gNB, an eNB, an eNodeB, a Home Node B, or a Home eNode B. Any of the first node 111, the second node 112, the third node 113, the one or more fourth nodes 114, the one or more fifth nodes 115 and the one or more sixth nodes 116 may be of different classes, such as, e.g., macro base station (BS), home BS or pico BS, based on transmission power and thereby also cell size. In some embodiments, any of the first node 111, the second node 112, the third node 113, the one or more fourth nodes 114, the one or more fifth nodes 115 and the one or more sixth nodes 116 may be implemented as one or more distributed nodes, such as virtual nodes in the cloud 120, and they may perform their functions entirely on the cloud 120, or partially, in collaboration with one or more radio network nodes.

Any of the first node 111, the second node 112, the third node 113, the one or more fourth nodes 114, the one or more fifth nodes 115 and the one or more sixth nodes 116 and the one or more sixth nodes 116 may be an IAB node.

The third node 113 may be a top-end node, that is, a top-level node, that is to migrate from the first node 111 to the second node 112.

The one or more fourth nodes 114 may be parent nodes of the third node 113.

The one or more fifth nodes 115 may be descendants of the third node 113.

The one or more sixth nodes 116 may be ancestor nodes. The one or more sixth nodes 116 may be served by the second node 112.

As depicted in the non-limiting examples of FIG. 9, the communications network 100 may comprise a multi-hop deployment, wherein the first node 111 may be a first donor node or source node, e.g., a first IAB-Donor CU, and the second node 112 may be a second donor node or target node, e.g., a second IAB-Donor CU. In some particular embodiments, any of the third node 113, the one or more fourth nodes 114, the one or more fifth nodes 115, and the one or more sixth nodes 116 may be a stationary relay/IAB node or a mobile relay/IAB node. A donor node may be understood to be, e.g., a node having a connection, e.g., a wired backhaul connection, to a core network node of the communications network 100, which is not depicted in FIG. 9 to simplify the Figure.

It may be understood that the communications network 100 may comprise more nodes, and more or other multi-hop arrangements, which are not depicted in FIG. 9 to simplify the Figure.

The communications network 100 covers a geographical area which may be divided into cell areas, wherein each cell area may be served by any of the first node 111, the second node 112, the third node 113, the one or more fourth nodes 114, the one or more fifth nodes 115 and the one or more sixth nodes 116, although, any of the first node 111, the second node 112, the third node 113, the one or more fourth nodes 114, the one or more fifth nodes 115 and the one or more sixth nodes 116 may serve one or several cells. In the non-limiting example of FIG. 9, not all the cells are depicted to simplify the Figure. FIG. 9 depicts one or more first cells 121 served by the one or more fifth nodes 115 and one or more second cells 122 served by the one or more sixth nodes 116. It may be understood that the communications network 100 may comprise more nodes, and more or other multi-hop arrangements, which are not depicted in FIG. 9 to simplify the Figure.

One or more devices may be located in the wireless communication network 100. FIG. 9, in a non-limiting manner depicts one or more devices 130 served directly by the third node 113, referred to herein as devices 130 served directly by the third node 113, which may be considered one or more first devices, one or more devices 140 served by the descendants 115 of the third node 113, referred to herein as devices 140 served by the descendants 115 of the third node 113, which may be considered as one or more second devices, and one or more devices 150 served by the descendants or the ancestors 116 served by the second node 112, which may be considered as one or more third devices. The one or more devices 130 served directly by the third node 113 and the one or more devices 140 served by the descendants 115 of the third node 113 may collectively referred to herein as devices 130, 140 served directly or indirectly by the third node 113.

Any of the one or more devices 130 served directly by the third node 113, the one or more devices 140 served by the descendants 115 of the third node 113 and/or the one or more devices 150 served by the descendants or the ancestors 116 served by the second node 112 may be a wireless device, e.g., a 5G UE, which may be a wireless communication device which may also be known as e.g., a UE, a mobile terminal, wireless terminal and/or mobile station, a mobile telephone, cellular telephone, or laptop with wireless capability, just to mention some further examples. The wireless device may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. The wireless device comprised in the communications network 100 is enabled to communicate wirelessly in the communications network 100. The communication may be performed e.g., via a RAN, and possibly the one or more core networks, which may be comprised within the communications network 100.

The first node 111 may be configured to communicate in the communications network 100 with the second node 112 over a first link 161. The first node 111 may be configured to communicate in the communications network 100 with the one or more fourth nodes 114 over a respective second link 162. The third node 113 may be configured to communicate in the communications network 100 with any of the one or more fourth nodes 114 over a respective third link 163. The third node 113 may be configured to communicate in the communications network 100 with any of the one or more fifth nodes 115 over a respective fourth link 164.

The second node 112 may be configured to communicate in the communications network 100 with any of the one or more sixth nodes 116 over a respective fifth link 165. The third node 113 may be configured to communicate in the communications network 100 with any of the one or more devices 130 served directly by the third node 113 over a respective sixth link 166. Any of the one or more fifth nodes 115 may be configured to communicate in the communications network 100 with any of the one or more devices 140 served by the descendants 115 of the third node 113 over a respective seventh link 167. Any of the one or more sixth nodes 116 may be configured to communicate in the communications network 100 with any of the one or more devices 150 served by the descendants or the ancestors 116 served by the second node 112 over a respective eighth link 168.

The hollow arrow in FIG. 9 represents the direction of a migration by the third node 113. This may happen, as a non-limiting example, after an RLF at one of the respective third links 163, represented in FIG. 9 with a hollow cross. However, as will be described later, this may be understood to not be the only circumstance leading to the migration.

Any of the first link 161, the respective second link 162, the respective third link 163, the respective fourth link 164, the respective fifth link 165, the respective sixth link 166, the respective seventh link 167, and the respective eighth link 168 may be, e.g., a radio link. The first link 161 may be typically a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, “fifth”, “sixth”, “seventh” and/or “eighth”, etc., herein may be understood to be an arbitrary way to denote different elements or entities, and may be understood to not confer a cumulative or chronological character to the nouns they modify, unless otherwise noted, based on context.

Several embodiments are comprised herein. Some embodiments herein will now be further described with some non-limiting examples. It should be noted that the examples herein are not mutually exclusive. Components from one embodiment may be tacitly assumed to be present in another embodiment and it will be obvious to a person skilled in the art how those components may be used in the other exemplary embodiments. Any of the details described in the following examples may be understood to be able to be combined with any of the embodiments described, as pertinent.

More specifically, the following are embodiments related to a first node, such as the first node 111, e.g., a first network node such as a first IAB-Donor CU, e.g., a source node, and embodiments related to a second node, such as the second node 112, such as a second IAB-Donor CU, e.g., a target node.

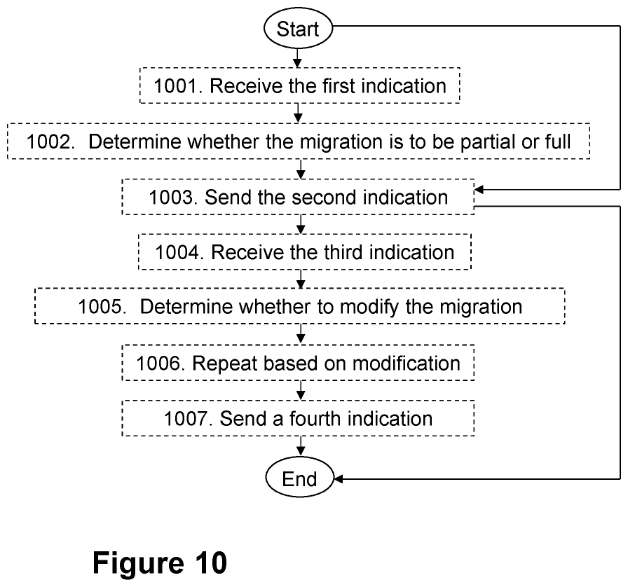

Embodiments of a method performed by a first network node, such as the first node 111, will now be described with reference to the flowchart depicted in FIG. 10. The method may be understood to be for handling migration of a node, such as the third node 113, e.g., a top end node or top-level node. The first node 111 operates in the communications network 100.

The communications network 100 may be a multi-hop deployment. In some embodiments, the communications network 100 may be an Integrated Access Backhaul (IAB) network.

In some embodiments, wherein the communications network 100 may be an Integrated Access and Backhaul (IAB) network, the first node 111 may be a source Centralized Unit (CU), the second node 112 may be a target CU, and the third node 113 may be a top-level IAB node. In the following description, any reference to the first node 111 may be understood to equally refer to the source donor CU, and/or CU1. Any reference to the second node 112 may be understood to equally refer to the target CU or CU2. Any reference to the third node 113 may be understood to equally refer the top-level IAB node.

Several embodiments are comprised herein. The method may comprise one or more of the following actions. In some embodiments all the actions may be performed. In other embodiments, one or more actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. Some actions may be performed in a different order than that shown in FIG. 10. In FIG. 10, actions which may be optional in some examples are depicted with dashed boxes.

### Action 1001

In this Action 1001, the first node 111 may receive a first indication from the second node 112. The first indication may request the context of the third node 113 from the first node 111. The third node 113 may be to be migrated from the first node 111 to the second node 112.

The context may be for control of radio resource. In some embodiments, the context may be an RRC context.

In some embodiments, the first indication may be a UE Context Retrieve Request.

The receiving may be performed, e.g., via the first link 161.

In an example of Action 1001, the first node 111 may, based on the received indication, determine that the first indication, e.g., the UE Context Retrieve Request may be associated to a top-level IAB node, such as the third node 113, that may have transmitted an RRCReestablishmentRequest or RRCResumeRequest to the second node 112, and whose last serving CU may have been the first node 111.

The first node 111, the source CU, may for example determine from the Cell-Radio Network Temporary Identifier (C-RNTI), or from an explicit “IAB node” flag indicated in the UE Context Retrieve Request message, that the request for the UE context retrieval may be for the third node 113, which may be an IAB node.

### Action 1002

In this Action 1002, the first node 111 may determine whether the indication is to be for a partial migration or a full migration. In an example of Action 1002, the first node 111 may determine for the concerned top level IAB node, whether a request for partial migration or full migration may need to be issued to the second node 112, the target CU.

### Determining May be Understood as Calculating, or Deriving.

In some embodiments, in partial migration, a mobile termination of the third node 113 may be to migrate to the second node 112, while F1 and (RRC) connections of its collocated DU and all descendant mobile terminations and Distributed Units and devices 130, 140 served directly or indirectly by the third node 113, may remain anchored at the first node 111. In some embodiments, in full migration, all the F1 and RRC connections of the third node 113 and all its descendants 115 and devices 130, 140 served directly or indirectly by the third node 113, may be to migrate to the second node 112.

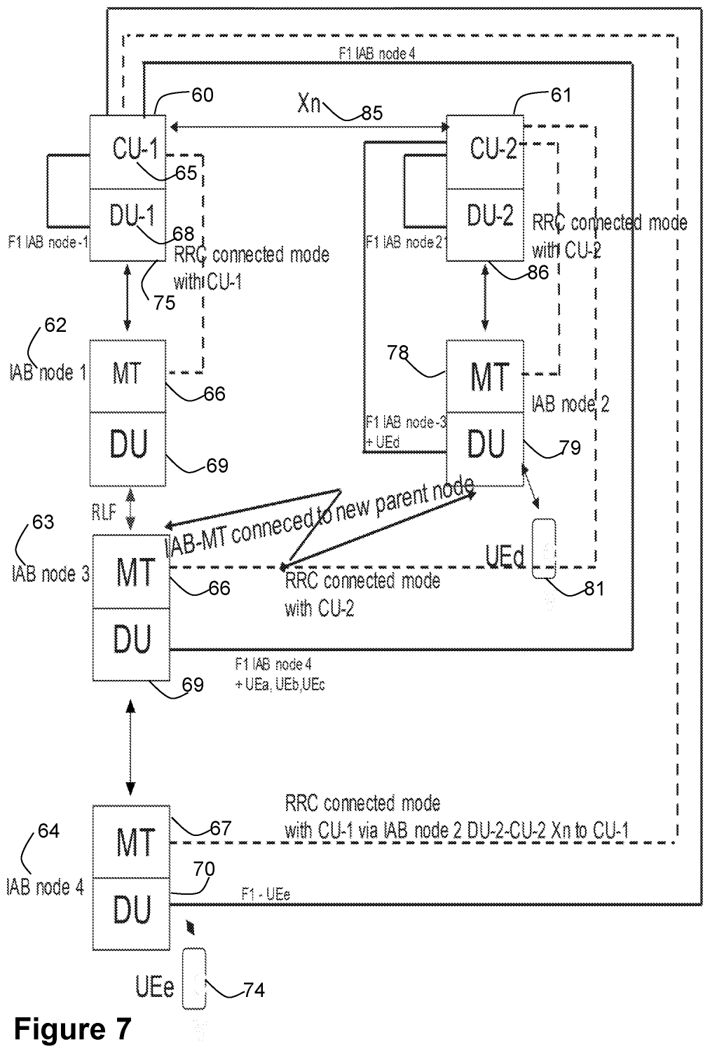

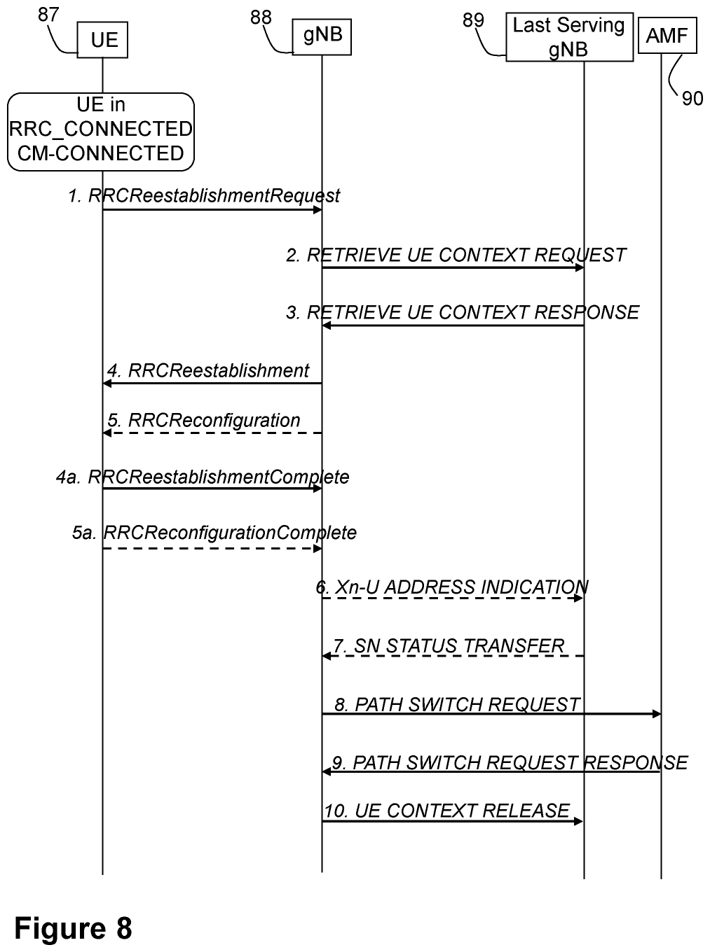

In some embodiments, the determining in this Action 1002 may be based on at least one of the following options or reasons. In a first option, the determining in this Action 1002 may be based on one or more measurements, e.g., between the third node 113 and the one or more fourth nodes 114, e.g., parent nodes, or potential parent nodes of the third node 113. The one or more radio measurements may be, e.g., Reference Signal Received Power (RSRP), Reference Signal Received Quality (RSRQ), Received Signal Strength Indicator (RSSI), etc, between the third node 113, the top level IAB node, and the parent IAB node(s) or other potential parent IAB nodes, under the source CU, such as e.g., IAB node 1 in FIG. 7 or the fourth node 114 in FIG. 9. For example, if the latest radio measurement received from the top level node related to the parent(s) under the source are poor, the first node 111, the source CU, may trigger a full migration to the second node 112, the target CU. Otherwise, the first node 111 may trigger a partial migration, e.g. if the measured RSRP may be above a certain threshold X. In this way, the first node 111 may have the possibility to keep receiving from the second node 112 the radio measurements that the third node 113 may be measuring with respect to the IAB nodes controlled by the first node 111. If at a certain point the measured RSRP towards at least one IAB node controlled by the first node 111, e.g. IAB1, is above a certain threshold Y, with Y>X, the first node 111 may trigger a handover for the third node 113 to migrate back to the parent node IAB1.

In another example of this example, the first node 111 may compare the radio measurements received from the third node 113 related to IAB nodes controlled by the source CU and IAB nodes controlled by the target CU. If the radio measurements measured with respect to a node under the second node 112, e.g. the sixth node 116 in FIG. 9, are persistently better, e.g., over a certain monitoring time period, than the radio measurements measured with respect to a node under the first node 111, e.g. the fourth node 114 in FIG. 9, then the first node 111 may issue a full migration. Otherwise, if the radio measurements measured with respect to a node under the second node 112 are only occasionally better than the radio measurements measured with respect to a node under the first node 111, the first node 111 may issue a partial migration.

In a second option, the determining in this Action 1002 may be based on whether or not the third node 113 is a mobile node. If the third node 113 is a mobile IAB node, the first node 111 may trigger a full migration, while if not, it may trigger a partial migration. The first node 111 may determine that the concerned IAB node is mobile by the IAB node capabilities or from the received radio measurements, or from its latest reported locations.

In a third option, the determining in this Action 1002 may be based on a number of failures experienced by the third node 113 with any parent node 114 of the third node 113. That is, on the amount of failures the third node 113 may have experienced with any parent node controlled by the first node 111 or the second node 112. For example, the first node 111 may determine from Self-Optimizing/Organizing Network (SON) reports, e.g., RLF reports or Radio Access (RA) reports, if the amount of RLFs or random access issues, the IAB node experienced with any parent node controlled by the first node 111 may be larger than the issues experienced with any parent node controlled by the second node 112. If it is larger, the first node 111 may request a full migration, otherwise a partial migration.

In a fourth option, the determining in this Action 1002 may be based on one or more indications received from the second node 112, e.g., a first indication received from the second node 112. The one or more indications may comprise, for example, explicit indications received from the second node 112 and included in the UE Context Retrieve Request. For example, the second node 112 may indicate that it may be able to accept full IAB migration or that it may not be able to accept a full IAB migration, e.g., depending on the current load/congestion status in the target. Additionally, it may also indicate whether it may be capable of supporting a partial migration, that is, whether it may be capable of acting as a proxy for the traffic to/from the top level IAB node and its descendant IAB nodes/UEs. In yet another example, the second node 112 may indicate that it may not be able to act as a donor, and that only a partial migration may be supported. Depending on the above indications, the first node 111 may determine whether a full migration or partial migration may be requested.

In a fifth option, the determining in this Action 1002 may be based on a load of the first node 111. That is, the determining in this Action 1002 may be based on the current or imminent traffic, that is, traffic load, and processing load at the first node 111. For example, if the load is currently high, or e.g., the traffic peak hours may be approaching, the first node 111 may decide to fully migrate to the target CU the devices, instead of continuing to serve them via the proxy-based approach.

### Action 1003

In this Action 1003, the first node 111 sends an indication to the second node 112 comprised in the communications network 100. In some embodiments, the indication may be referred to later as a “second indication”. The indication indicates the context of the third node 113, comprised in the communications network 100, to be migrated from the first node 111 to the second node 112. The context is for control of radio resource. The indication may be a UE Context Retrieve Response.

A content of the indication is based on whether the migration of the third node 113 is to be partial or full, as e.g., it may have been determined in Action 1002.

In particular examples, the determining in this Action 1003 may be performed wherein the migration of the third node 113 is to be partial, e.g., in examples wherein the third node 113 may retain its F1 connection with the first node 111, after the third node 113 may have connected with the second node 112.

In examples of Action 1003, if a partial migration is determined, the first node 111 may include the RRC context of the third node 113, the properties of the ingress, for downstream traffic, and egress, for upstream traffic, BH RLC channels of the top level node, such as the QoS flow identifiers associated to each of such BH RLC channels, their QoS flow parameters, such as priority, latency budget, etc, the aggregated maximum bit rate served by the top level IAB node, the Guaranteed Bit Rate (GBR) QoS information of each BH RLC channel etc.

Additionally, the first node 111 may indicate how many descendant IAB nodes may be served directly or indirectly by the third node 113, and optionally their BAP and IP addresses, e.g., the number and type of IP addresses assigned to each node, as well as the network topology of the network branch including the top level node and all the nodes directly or indirectly served by it. The second node 112 may then assign to each of such descendant IAB node a new BAP/IP address if not provided by the first node 111, so that the target donor may update the routing tables of the ancestor nodes of the third node 113, and hence set the proper BAP routing ID in the BAP packet destined to the third node 113 or descendant IAB node.

If a full migration is determined, the first node 111 may include the RRC contexts and the aforementioned properties of all the ingress/egress BH RLC channels for each descendant IAB node. Additionally, for each descendant IAB node that may be intended to be migrated to the second node 112 and for each ingress/egress BH RLC channel associated to such descendant IAB node, the first node 111 may indicate the associated BH routing information, such as the BAP routing IDs, the BAP address of the next hop, the BAP address of the prior hop. The first node 111 may also include for each descendant IAB node and for the top level node, the list of the child/parent IAB nodes, wherein each IAB node may be represented by an identity such as the F1AP ID of the IAB, the list of UEs, e.g., represented by the F1AP ID of the UE, connected to it, or its BAP address, and the list of cells, represented by the NR Cell Global Identity (CGI), served by it.

In the case of full migration, the first node 111 may also include the RRC contexts of each UE served directly or indirectly by the third node 113, as well as the properties of their DRBs and associated QoS flow parameters and information, as well as the Signaling Radio Bearers (SRBs) and the associated information. The first node 111 may also indicate for each device, e.g., UE, the identity of the IAB node to which the UE may be currently connected, that is, the IAB access node for that DRB. The first node 111 may also include the BAP addresses and BAP routing IDs and the number and type of IP addresses pertaining to each IAB node to be migrated. The first node 111 may also include radio resource configurations of all the nodes, including the parameters pertaining to the coordination of Time Division Duplex (TDD) resources between each parent and child links of each IAB node.

The first node 111 may also include in the message an explicit indication indicating that a full or partial migration may be requested. Alternatively, the second node 112 may infer whether a full or partial migration may be requested depending on the content of the message. For example, if the UE Context Retrieve Response only includes the RRC context of one IAB node and the properties of the related ingress, for downstream traffic, and egress, for upstream traffic, BH RLC channels of one IAB node, the second node 112 may deduce that a partial migration is requested for the concerned IAB node, that is, the third node 113. Otherwise, if also the RRC contexts of descendant IAB nodes and UEs are included, then the second node 112 may deduce that a full migration may be required.

The sending in this Action 1003 of the indication is performed in response to the first indication received from the second node 112.

Sending may be understood as transmitting, or providing, e.g., via the first link 141.

As stated earlier, the first indication requests the context of the third node 113 from the first node 111.

In some embodiments, the first indication may be a UE Context Retrieve Request and the second indication may be a UE Context Retrieve Response.

The sent indication in this Action 1003 may be based on a first result of the determination performed in Action 1002. In general terms, in some embodiments, with the proviso that the migration is to be partial, the indication may indicate first information pertaining to the third node 113. With the proviso that the migration is to be full, the indication may indicate the first information pertaining to the third node 113 and second information pertaining to the descendants 115 of the third node 113, and/or any, or all, of the devices 130, 140 served directly or indirectly by the third node 113.

In some embodiments, at least one of the following may apply. According to a first group of embodiments, with the proviso that the migration is to be partial, the indication may further indicate one or more of: i) one or more properties of ingress and egress BackHaul Radio Link Control (BH RLC) channels of the third node 113, ii) a number of descendants 115 of the third node 113, iii) a respective address of the descendants 115 of the third node 113, e.g., a number and type of IP addresses assigned to each node may be indicated, iv) information on a topology of a branch of the communications network 100 wherein the third node 113 may be located, v) a first explicit indication that partial migration is requested, and vi) a respective number and type of IP addresses assigned to each of the descendants 115 of the third node 113 and the third node 113. According to a second group of embodiments, with the proviso that the migration is to be full, the indication may further indicate one or more of: i) the one or more properties of ingress and egress BH RLC channels of the third node 113, ii) the number of descendants 115 of the third node 113, iii) the respective address the descendants 115 of the third node 113, e.g., BAP address, and/or a number and type of IP addresses assigned to each node, iv) the information on the topology of the branch of the communications network 100 wherein the third node 113 may be located, v) a first respective context for control of radio resource for the descendants 115 of the third node 113, vi) respective one or more properties of ingress and egress BH RLC channels of the descendants 115 of the third node 113, vii) a respective routing information for the descendants 115 of the third node 113, viii) a respective number of descendants of the descendants 115 of the third node 113, ix) a respective number of parents of the descendants of the third node 113, x) a respective number of devices 140 served by the descendants 115 of the third node 113, xi) a respective list of one or more first cells 121 served by the descendants 115 of the third node 113, xii) a second respective context for control of radio resource for the devices 130, 140 served directly or indirectly by the third node 113, xiii) one or more respective properties of radio bearers of the devices served directly or indirectly by the third node 113, xiv) respective information of one or more flows of the devices 130, 140 served directly or indirectly by the third node 113, xv) respective topology information for the devices 130, 140 served directly or indirectly by the third node 113, xvi) a second explicit indication that full migration is requested, and xvii) respective BAP address, and/or a respective number and type of IP addresses assigned to each node to be migrated.

### Action 1004

As stated earlier, the indication sent in Action 1003 may be understood to be a second indication. In this Action 1004, the first node 111 may receive a third indication from the second node 112. The third indication may indicate whether or not the migration is accepted. The receiving in this Action 1004 of the third indication may be based on the sent second indication.

In some embodiment, the third indication may indicate whether or not the migration is accepted, or whether or not to modify the migration.

The receiving may be performed, e.g., via the first link 161.

In an example of Action 1004, the third indication may be, for example, a, newly defined, UE Context Retrieve Acknowledgment from the target CU.

### Action 1005

In this Action 1005, the first node 111 may determine whether or not to modify the migration based on the received third indication. That is, whether or not any modification to the migration request may be necessary.

In some embodiments, the determining in this Action 1005 may be based on the received third indication. In an example of Action 1005, the first node 111 may determine, e.g., from the UE Context Retrieve Acknowledgment, whether the second node 112 accepted the migration requested in Action 1003, or if any modification to that request may be necessary.

### Action 1006

In some embodiments, the first node 111 may, in this Action 1006, repeat the sending in Action 1003 of the indication, the receiving in Action 1004 of the third indication, and the determining of Action 1005 of whether or not to modify the migration. The repeating in this Action 1006 may be based a second result of the determination of whether or not to modify the migration of Action 1005.

In an example of Action 1006, the first node 111 may repeat Actions 1003-1005 if any modification to the last transmitted UE Context Retrieve Response may be necessary. For example, the first node 111, upon receiving the UE Context Retrieve Acknowledgment may deconfigure certain BH RLC channels associated to a given IAB node, or modify their configuration such that the QoS properties of the BH RLC channel may be sustained by the second node 112. For example, the first node 111 may release the UEs or some of their DRBs whose traffic may be conveyed in a given BH RLC channel such that the maximum bit rate in this BH RLC channel may be guaranteed by the second node 112. The first node 111 may also release some of the IAB nodes below the third node 113, the top level node.

### Action 1007

In some embodiments wherein the indication may be the second indication, and the migration may be to be partial, the first node 111 may, in this Action 1007, send a fourth indication to the third node 113. The fourth indication may indicate an F1 configuration update.

Sending may be understood as transmitting, or providing, e.g., via the first link 141. In an example of Action 1007, in case the migration requested and acknowledged by the second node 112 is partial migration, an F1 configuration update to the third node 113, wherein this F1 configuration updated may have been signaled by the second node 112 in the UE Context Retrieve Acknowledgment in Action 1004. For example, such F1 configuration update may indicate the BH Routing information that may be needed by the third node 113 to communicate with its ancestor IAB nodes under the second node 112, as well as the new ingress, for the downstream traffic, and egress, for the upstream traffic, BH RLC channels between the third node 113 and its new parent IAB node. The F1 configuration update may also include updates for the descendant IAB nodes in case certain BH RLC channels may need to be removed or their QoS properties, for user plane BH RLC channels, or priorities, for control plane BH RLC channels, may need to be modified.

Additionally, the F1 configuration update may include a mapping table signalled in the UE Context Retrieve Acknowledgment, that may map BAP routing ID/BH RLC channels/BAP addresses/IP addresses assigned by the second node 112 into BAP routing ID/BH RLC channels/BAP addresses/IP addresses configured previously, that is, before the reception of the UE Context Retrieve Request, by the first node 111. This mapping table may then be used by the third node 113 to route the received BAP packet to the intended descendant IAB access node, e.g. by overwriting the BAP header fields, that is, the BAP Routing ID, with the BAP Routing ID needed for BH communications with its descendant IAB nodes and/or overwriting its IP header fields with the IP address needed for BH communications with its descendant IAB nodes, or, alternatively removing the IP header in which the packet may have been encapsulated by the source donor CU.

The first node 111 may also provide an RRCReconfiguration to the UEs served by the third node 113 or any of its descendant IAB nodes, e.g. removing/adding DRBs.

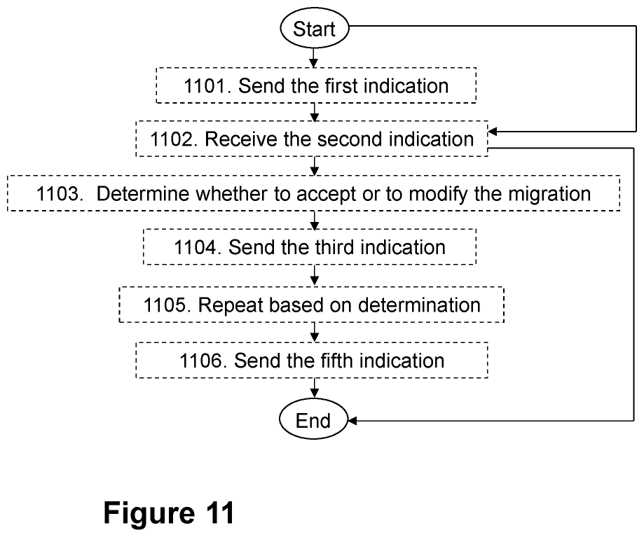

Embodiments of a method, performed by a another node, such as the second node 112, will now be described with reference to the flowchart depicted in FIG. 11. The method may be understood to be for handling migration of a node. The second node 112 operates in the communications network 100.

The communications network 100 may be a multi-hop deployment. In some embodiments, the communications network 100 may be an IAB network.

The method may comprise one or more of the following actions.

Several embodiments are comprised herein. In some embodiments all the actions may be performed. In other embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the second node 112 is depicted in FIG. 11. Some actions may be performed in a different order than that shown in FIG. 11. In FIG. 11, actions which may be optional in some examples are depicted with dashed boxes.

The detailed description of some of the following corresponds to the same references provided above, in relation to the actions described for the first node 111 and will thus not be repeated here. For example, in some embodiments, wherein the communications network 100 may be an IAB network, the first node 111 may be a source CU, the second node 112 may be a target CU, and the third node 113 may be a top-level IAB node. In the following description, any reference to the first node 111 may be understood to equally refer to the source donor CU, and/or CU1. Any reference to the second node 112 may be understood to equally refer to the target CU or CU2. Any reference to the third node 113 may be understood to equally refer the top-level IAB node.

### Action 1101

In this Action 1101, the second node 112 may send the first indication to the first node 111.

The first indication may request the context of the third node 113 from the first node 111.

The sending, or transmitting, may be performed, e.g., via the first link 161.

The context may be for control of radio resource. In some embodiments, the context may be the RRC context.

In some embodiments, the first indication may be the UE Context Retrieve Request. In an example of Action 1101, such message may be transmitted upon receiving from the third node 113, a top level IAB node, an RRCReestablishmentRequest or RRCResumeRequest message. It may optionally include an indication of whether the device that may be attempting the reestablishment/resume is an IAB node or a UE. This may be deduced from information included in the RRCReestablishmentRequest/RRCResumeRequest, such as a flag indicating that this is an IAB node, or an ID that may identify that this an IAB node.

The first indication may further indicate, e.g., based on one or more conditions or capabilities, whether or not the second node 112 may be able to accept a full migration or a partial migration.

In some embodiments, in partial migration, the mobile termination of the third node 113 may be to migrate to the second node 112, while the F1 and RRC connections of its collocated DU and all descendant mobile terminations and Distributed Units and devices 130, 140 served directly or indirectly by the third node 113, may remain anchored at the first node 111. In some embodiments, in full migration, all the F1 and RRC connections of the third node 113 and all its descendants 115 and devices 130, 140 served directly or indirectly by the third node 113, may be to migrate to the second node 112.

The fact that the first indication may indicate whether or not the second node 112 may be able to accept a full migration or a partial migration based on one or more conditions may relate to, e.g., the current load/congestion status in the second node 112 and/or radio conditions. For example, the message may also include an indication indicating that the second node 112 may accept full IAB migration or that it may not be able to accept a full IAB migration, e.g., depending on the current load/congestion status in the target.

Additionally, it may also indicate whether it may be capable of supporting a partial migration, that is, whether it may be capable of acting as a proxy for the traffic to/from the third node 113 and its descendant IAB nodes/UEs. In yet another example, the second node 112 may indicate that it may not be able to act as a donor, and that only a partial migration may be supported. The indication of capability to support full and/or proxy-based migration may be both in terms of features supported by the target donor and in terms of current state of traffic and/or radio conditions. For example, a donor may be able to support both migration types, but unable to provide these services to the source donor due to traffic load.

That is, that the first indication may indicate whether or not the second node 112 may be able to accept a full migration or a partial migration based on one or more capabilities may relate to a capability of the second node 112 to support one type of migration or the other, to act as or not a donor, and one or more features supported by the second node 1112 which may depend on current state of traffic and/or radio conditions.

### Action 1102

In this Action 1102, the second node 112 receives the indication, e.g., also referred to herein as the second indication, from the first node 111 comprised in the communications network 100. The indication indicates the context of the third node 113, comprised in the communications network 100. The third node 113 is to be migrated from the first node 111 to the second node 112. The context is for control of radio resource. In some embodiments, the context may be the RRC context.

The content of the indication is based on whether the migration of the third node 113 is to be partial or full.

The receiving in this Action 1102 of the indication is performed in response to the first indication sent by the second node 112. As stated earlier, the first indication requests the context of the third node 113 from the first node 111.

Receiving may be performed, e.g., via the first link 141.

In an example of Action 1102, the indication may be a UE Context Retrieve Response.

In some embodiments, the first indication may be the UE Context Retrieve Request and the second indication may be the UE Context Retrieve Response.

In general terms, in some embodiments, with the proviso that the migration is to be partial, the indication may indicate first information pertaining to the third node 113. With the proviso that the migration is to be full, the indication may indicate the first information pertaining to the third node 113 and second information pertaining to the descendants 115 of the third node 113, and/or any, or all, of the devices 130, 140 served directly or indirectly by the third node 113.

In some embodiments, at least one of the following may apply. According to the first group of embodiments, with the proviso that the migration is to be partial, the indication may further indicate one or more of: i) the one or more properties of ingress and egress BH RLC channels of the third node 113, ii) the number of descendants 115 of the third node 113, iii) the respective address of the descendants 115 of the third node 113, e.g., a number and type of IP addresses assigned to each node may be indicated, iv) the information on the topology of the branch of the communications network 100 wherein the third node 113 may be located, v) the first explicit indication that partial migration is requested, and vi) a respective number and type of IP addresses assigned to each of the descendants 115 of the third node 113 and the third node 113. According to the second group of embodiments, with the proviso that the migration is to be full, the indication may further indicate one or more of: i) the one or more properties of ingress and egress BH RLC channels of the third node 113, ii) the number of descendants 115 of the third node 113, iii) the respective address the descendants 115 of the third node 113, e.g., BAP address, and/or a number and type of IP addresses assigned to each node to be migrated may be indicated, iv) the information on the topology of the branch of the communications network 100 wherein the third node 113 may be located, v) the first respective context for control of radio resource for the descendants 115 of the third node 113, vi) the respective one or more properties of ingress and egress BH RLC channels of the descendants 115 of the third node 113, vii) the respective routing information for the descendants 115 of the third node 113, viii) the respective number of descendants of the descendants 115 of the third node 113, ix) the respective number of parents of the descendants of the third node 113, x) the respective number of devices 140 served by the descendants 115 of the third node 113, xi) the respective list of one or more first cells 121 served by the descendants 115 of the third node 113, xii) the second respective context for control of radio resource for the devices 130, 140 served directly or indirectly by the third node 113, xiii) the one or more respective properties of the radio bearers of the devices served directly or indirectly by the third node 113, xiv) the respective information of one or more flows of the devices 130, 140 served directly or indirectly by the third node 113, xv) the respective topology information for the devices 130, 140 served directly or indirectly by the third node 113, xvi) the second explicit indication that full migration is requested, and xvii) respective BAP address, and/or a respective number and type of IP addresses assigned to each node to be migrated.

In some embodiments, the method may comprise one or more of the following actions:

In some embodiments, the indication may be a second indication.

### Action 1103

In this Action 1103, the second node 112 may determine whether or not the migration may be accepted, or whether or not to modify the migration. That is, whether the migration may be conditionally accepted. The determining in this Action 1103 may be based on the received indication, that is, the second indication.

For this evaluation, the second node 112 may consider a plurality of factors which may be taken into account in the admission control. In some embodiments, the determining in this Action 1103 may be based on at least one of the two following factors. A first factor may be a load of one or more of: the second node 112, one or more ancestors 116 served by the second node 112, one or more second cells 122 of the ancestors 116, one or more descendants 115 of the third node 113, devices 130, 140 served directly or indirectly by the third node 113, and one or more third devices 150 served by the descendants or the ancestors 116 served by the second node 112. In an example of Action 1103, the determining in this Action 1103 may be based on the load, including the amount DRBs or BH RLC channels or UEs configured, the radio resource utilization of the CU, as well as the load of the ancestor IAB nodes and their served cells, wherein the ancestor IAB nodes may be the IAB nodes that may serve directly or indirectly the third node 113 and its descendant IAB nodes/UEs, upon reestablishment/resume completion of the third node 113.

A second factor may be one or more quality of service (QOS) properties of one or more of: channels, bearers and priorities indicated in the received indication. In an example of Action 1103, the determining in this Action 1103 may be based on the QoS properties of the user plane BH RLC channels and DRBs indicated and priorities of control plane BH RLC channels in the UE Context Retrieve Response.

### Action 1104

As stated earlier, the indication received in Action 1102 may be understood to be a second indication. In this Action 1104, the second node 112 may send the third indication to the first node 111. The third indication may indicate whether or not the migration is accepted, or whether or not to modify the migration. The sending in this Action 1104 of the third indication may be based on a third result of the determining performed in Action 1103.

The sending, or transmitting, may be performed, e.g., via the first link 161.

In an example of Action 1104, the third indication may be a UE Context Retrieve Acknowledgment to the first node 111, wherein such message may contain the following information depending on the decision taken in Action 1103. According to a first option, the message may contain an indication that the migration request indicated in Action 1102 is accepted. In one example, in case the migration is accepted, no UE Context Retrieve Acknowledgment may be transmitted. In another example, the UE Context Retrieve Acknowledgment that may be transmitted may indicate that only a subset of traffic and/or nodes may be accepted.

According to a second option, the message may contain an indication that the migration request indicated in Action 1102 is not accepted and that instead, a different type of migration may be accepted. For example, the second node 112 may indicate that a full migration requested in Action 1102 may not be accepted, and it may be optionally indicated that a partial, that is, proxy based, migration may be supported by the second node 112 and may be accepted.

According to a third option, the message may contain an indication that the migration request indicated in Action 1102 may be conditionally accepted, wherein the second node 112 may indicate that the concerned migration may be accepted subject to certain modifications to the RRC context or to the F1 configurations of a given IAB node. For example, the second node 112 may indicate the source CU to remove certain BH RLC channels associated to one IAB node or to modify their properties such as the QoS related parameters. The second node 112 may indicate a preferred configuration of the BH RLC channel and their QoS, e.g. the maximum bit rate, the minimum packet delay budget that may be sustained by the second node 112.

According to a fourth option, in case of partial migration, the second node 112 may also indicate to the first node 111 the BH Routing Information, including e.g., the BAP address of the parent node, the BAP Routing IDs, the BAP address of the donor target DU, that may be needed for the top level IAB node to communicate with its ancestor nodes and target donor DU after the reestablishment/resume completion. This step may be needed since the BH Routing Information may be transmitted via F1 signalling, and since the F1 connection may be retained at the second node 112 in case of partial migration, the first node 111 may need to provide an F1 configuration update indicating the BH Routing information that may be needed by the third node 113 to communicate with its ancestor IAB nodes under the second node 112.

According to a fifth option, additionally, the second node 112 may indicate to the first node 111, for each of the descendant IAB node, a new BAP address and IP addresses, which may be the BAP address and IP addresses used in the second node 112 to route packets to the IAB node descendant of the top level IAB node. The first node 111 may then build a mapping table that may map BAP routing ID/BH RLC channels/BAP addresses/IP addresses assigned by the second node 112 into BAP routing ID/BH RLC channels/BAP addresses/IP addresses configured previously, that is, before the reception of the UE Context Retrieve Request, by the first node 111, see action 1007.

### Action 1105

In this Action 1105, the second node 112 may repeat, one or more of, or all of, the receiving in Action 1102 of the of the second indication, the determining in Action 1103 of whether or not the migration is accepted, or whether or not to modify the migration, and the sending in Action 1104 of the third indication. The repeating in this Action 1105 may be based on a third result of the determination of whether or not to modify the migration.

In an example of Action 1105, the second node 112 may repeat Action 1102-Action 1104 if the UE Context Retrieve Acknowledgment implies that a modification to the migration request of the first node 111 may be required.

### Action 1106

In this Action 1106, with the proviso that the migration is accepted, the second node 112 may send a fifth indication. In some embodiments, with the proviso that the migration is partial, the fifth indication may be sent to the third node 113, and the fifth indication may indicate: information for radio resource control. In some embodiments, with the proviso that the migration is full, the fifth indication may indicate one or more of: i) the information for radio resource control; in these embodiments, the fifth indication may be sent to one or more of: the third node 113, one or more descendants 115 of the third node 113, and devices 130, 140 served directly or indirectly by the third node 113, and ii) an updated F1 configuration; in these embodiments, the fifth indication may be sent to one or more of: the third node 113, and one or more descendants 115 of the third node 113.

The sending may be understood as e.g., transmitting.

In an example of Action 1106, if the outcome of the decision in Action 1103 is that the migration requested by the source CU is accepted, the second node 112 may transmit, to the third node 113, an RRCReestablishment or RRCResume, or RRCSetup message. If the migration is a full migration, the second node 112 may also transmit to the descendant IAB nodes/UEs an RRCReestablishment or RRCResume or RRCSetup message. Additionally, if the migration is a full migration, the second node 112 may provide an F1 configuration update to the third node 113 and descendant IAB nodes, comprising for each IAB node updated BH routing information, including BAP routing IDs, the BAP address of the next hop, the BAP address of the prior hop. Additionally, the F1 configuration update may also include updated ingress/egress BH RLC Channels, e.g., with update QoS properties, for user plane BH RLC channels, or priority, for control plane BH RLC channels, or indication of removal/addition of certain BH RLC channel, associated to each IAB node.

As a summarized overview of the foregoing, examples herein may be understood to relate to methods for a first network node, say a source CU of:
Receiving a UE Context Retrieve Request from a second network node, say a target CU, and determining that the said UE Context Retrieve Request may be associated to a third network node, say a top-level IAB node, that is, the IAB node that may have issued an RRC Reestablishment or resume to the second network node.
Determining, for such IAB node, whether a full migration of the IAB node, its descendant IAB nodes, and UEs may be, or may have to be, performed, described in the Background Section entitled Inter-CU migration in Rel17, or if a partial migration, e.g., a proxy-based solution described in the Background Section entitled Inter-CU migration in Rel17, may be, or may have to be initiated upon reestablishment/resume.
Transmitting, to the second network node, the UE Context Retrieve Response, containing the context of the top level node, third network node, and optionally the contexts of the descendant IAB nodes, including their IAB-MT and IAB-DU contexts, and the contexts of their served UEs, as well as the amount of resources necessary for serving the traffic to/from these IAB nodes and UEs.
Receiving, from the second network node, a newly defined UE Context Retrieve Acknowledgment, upon which the first network node may modify the decision on whether full migration or partial migration may be, or may have to be performed for the concerned third network node. The notification of such modification may be transmitted in a second UE Context Retrieve Response, upon which a second UE Context Retrieve Acknowledgment from the second network node may be expected, or in newly defined messages.

Embodiments herein may comprise the following methods for a second network node, say target CU of:
Transmitting a UE Context Retrieve Request to the first network node upon receiving an RRCReestblishmentRequest or RRCResumeRequest from the third network node, that is, say top-level IAB node.
Receiving from the first network node a UE Context Retrieve Response.
Determining from the UE Context Retrieve Response whether the reestablishment/resume request of top level IAB node, and optionally of its IAB descendant nodes and UEs, may be accepted. Such decision may be based on whether a full or partial migration may have been requested by the first network node.
Transmitting to the first network node a newly defined UE Context Retrieve Acknowledgment indicating whether the full or partial migration requested by the first network node in the UE Context Retrieve Response is accepted or not. The UE Context Retrieve Acknowledgment may also convey a recommendation to the first network node to change the type of migration, e.g., if a full migration was requested by the first network node in the UE Context Retrieve Response, the second network node may recommend the first network node to initiate a partial migration.

Certain embodiments disclosed herein may provide one or more of the following technical advantage(s), which may be summarized as follows.

As a first advantage, embodiments herein may accommodate both flavors of inter-donor migration: full and proxy-based migration. The source and target CU may have the possibility to exchange information related to the context of a migrating IAB node, say top level IAB node, and optionally of the descendant IAB nodes and UEs served by such migrating IAB node and the information about the necessary resources to serve the traffic to/from these devices, thereby allowing the migrating top-level node, and its descendant IAB nodes/UEs, to continue communications with the network.

As another advantage, embodiments herein may enable the source CU and target CU to exchange information on the type of migration needed, that is, full migration or partial migration, and hence to select the preferred migration type.

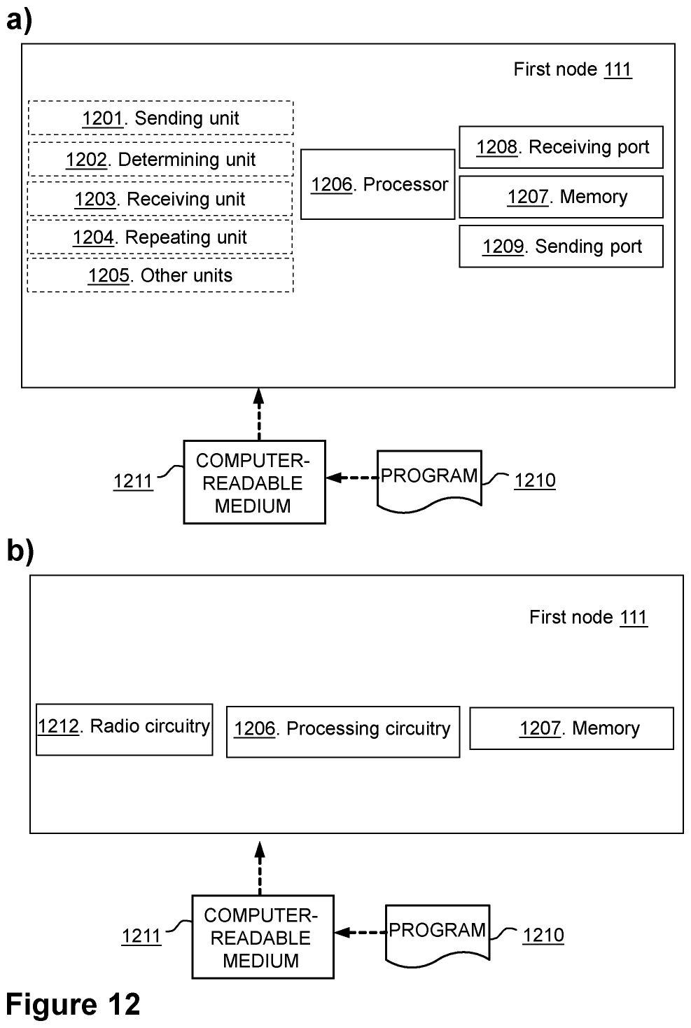

FIG. 12 depicts two different examples in panels a) and b), respectively, of the arrangement that the first node 111 may comprise. In some embodiments, the first node 111 may comprise the following arrangement depicted in FIG. 12a. The first node 111 may be understood to be for handling migration of a node. The first node 111 is configured to operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111, and will thus not be repeated here. For example, in some embodiments, wherein the communications network 100 may be configured to be an IAB network, the first node 111 may be configured to be a source CU, the second node 112 may be configured to be a target CU, and the third node 113 may be configured to be a top-level IAB node.

In FIG. 12, optional units are indicated with dashed boxes.

The first node 111 is configured to perform the sending of Action 1003 action, e.g. by means of a sending unit 1201 within the first node 111 configured to, send the indication to the second node 112 configured to be comprised in the communications network 100. The indication is configured to indicate the context of the third node 113. The third node 113 is configured to be comprised in the communications network 100 and configured to be migrated from the first node 111 to the second node 112. The context is configured to be for control of radio resource. The content of the indication is configured to be based on whether the migration of the third node 113 is to be partial or full. The sending of the indication is configured to be performed in response to the first indication configured to be received from the second node 112. The first indication is configured to request the context of the third node 113 from the first node 111.

In some embodiments, in partial migration, the mobile termination of the third node 113 may be configured to migrate to the second node 112, while the F1 and (RRC) connections of its collocated DU and all descendant mobile terminations and Distributed Units and devices 130, 140 configured to be served directly or indirectly by the third node 113, may be configured to remain anchored at the first node 111. In some embodiments, in full migration, all the F1 and RRC connections of the third node 113 and all its descendants 115 and devices 130, 140 configured to be served directly or indirectly by the third node 113, may be configured to migrate to the second node 112.

In some embodiments, at least one of the following may apply. According to the first group of embodiments, with the proviso that the migration is to be partial, the indication may be configured to further indicate one or more of: i) the one or more properties of ingress and egress BH RLC channels of the third node 113, ii) the number of descendants 115 of the third node 113, iii) the respective address of the descendants 115 of the third node 113, e.g., a number and type of IP addresses configured to be assigned to each node may be configured to be indicated, iv) the information on the topology of the branch of the communications network 100 wherein the third node 113 may be located, v) the first explicit indication that partial migration is requested, and vi) a respective number and type of IP addresses configured to be assigned to each of the descendants 115 of the third node 113 and the third node 113. According to the second group of embodiments, with the proviso that the migration is to be full, the indication may be configured to further indicate one or more of: i) the one or more properties of ingress and egress BH RLC channels of the third node 113, ii) the number of descendants 115 of the third node 113, iii) the respective address the descendants 115 of the third node 113, e.g., BAP address, and/or a number and type of IP addresses configured to be assigned to each node configured to be migrated may be configured to be indicated, iv) the information on the topology of the branch of the communications network 100 wherein the third node 113 may be configured to be located, v) the first respective context for control of radio resource for the descendants 115 of the third node 113, vi) the respective one or more properties of ingress and egress BH RLC channels of the descendants 115 of the third node 113, vii) the respective routing information for the descendants 115 of the third node 113, viii) the respective number of descendants of the descendants 115 of the third node 113, ix) the respective number of parents of the descendants of the third node 113, x) the respective number of devices 140 configured to be served by the descendants 115 of the third node 113, xi) the respective list of one or more first cells 121 configured to be served by the descendants 115 of the third node 113, xii) the second respective context for control of radio resource for the devices 130, 140 configured to be served directly or indirectly by the third node 113, xiii) the one or more respective properties of radio bearers of the devices configured to be served directly or indirectly by the third node 113, xiv) the respective information of one or more flows of the devices 130, 140 configured to be served directly or indirectly by the third node 113, xv) the respective topology information for the devices 130, 140 configured to be served directly or indirectly by the third node 113, xvi) the second explicit indication that full migration is requested, and xvii) respective BAP address, and/or a respective number and type of IP addresses configured to be assigned to each node to be migrated.

In some embodiments, the context may be configured to be an RRC context.

The first node 111 may be further configured to perform the determining of Action 1002, e.g. by means of a determining unit 1202 within the first node 111 configured to, determine whether the indication is to be for a partial migration or a full migration, and the indication configured to be sent may be configured to be based on the first result of the determination.

In some embodiments, the determining may be configured to be based on at least one of: a) the one or more measurements between the third node 113 and one or more fourth nodes 114, b) whether or not the third node 113 may be configured to be a mobile node, c) the number of failures configured to be experienced by the third node 113 with any parent node 114 of the third node 113, d) the one or more indications configured to be received from the second node 112, and e) the load of the first node 111.

In some embodiments, the indication may be configured to be the second indication and the first node 111 may be configured to perform the receiving of Action 1001, e.g. by means of a receiving unit 1203 within the first node 111 configured to, receive the first indication from the second node 112.

In some embodiments, the first indication may be configured to be a UE Context Retrieve Request and the second indication may be configured to be a UE Context Retrieve Response.

In some embodiments, the indication may be configured to be the second indication and the first node 111 may be further configured to perform the receiving of Action 1004, e.g. by means of the receiving unit 1203 within the first node 111 configured to, receive the third indication from the second node 112. The third indication may be is configured to indicate whether or not the migration is accepted. The receiving of the third indication may be configured to be based on the second indication configured to be sent.

The first node 111 may be further configured to perform the determining of Action 1005, e.g. by means of the determining unit 1202 within the first node 111 configured to, determine whether or not to modify the migration based on the third indication configured to be received.

The first node 111 may be further configured to perform the repeating of Action 1006, e.g. by means of a repeating unit 1204 within the first node 111 configured to, repeat the sending of the indication, the receiving of the third indication, and the determining of whether or not to modify the migration, based the second result of the determination of whether or not to modify the migration.

In some embodiments, wherein the indication may be configured to be the second indication and the migration is to be partial, the first node 111 may be further configured to perform the sending of Action 1006 action, e.g. by means of the sending unit 1201 within the first node 111 configured to, send the fourth indication to the third node 113. The fourth indication may be configured to indicate the F1 configuration update.

Other units 1205 may be comprised in the first node 111.

The embodiments herein in the first node 111 may be implemented through one or more processors, such as a processor 1206 in the first node 111 depicted in FIG. 12a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1207 comprising one or more memory units. The memory 1207 is arranged to be used to store obtained information, store data, configurations, schedulings, and applications etc. to perform the methods herein when being executed in the first node 111.

In some embodiments, the first node 111 may receive information from, e.g., any of the second node 112, the third node 113, the one or more fourth nodes 114, the one or more fifth nodes 115, the one or more sixth nodes 116, the one or more devices 130 served directly by the third node 113, the host computer 1510, and/or any of the other nodes or devices, the, through a receiving port 1208. In some embodiments, the receiving port 1208 may be, for example, connected to one or more antennas in first node 111. In other embodiments, the first node 111 may receive information from another structure in the communications network 100 through the receiving port 1208. Since the receiving port 1208 may be in communication with the processor 1206, the receiving port 1208 may then send the received information to the processor 1206. The receiving port 1208 may also be configured to receive other information.

The processor 1206 in the first node 111 may be further configured to transmit or send information to e.g., any of the second node 112, the third node 113, the one or more fourth nodes 114, the one or more fifth nodes 115, the one or more sixth nodes 116, the one or more devices 130 served directly by the third node 113, the host computer 1510, and/or any of the other nodes or devices, or another structure in the communications network 100, through a sending port 1209, which may be in communication with the processor 1206, and the memory 1207.

Those skilled in the art will also appreciate that the units 1201-1205 described above may refer to a combination of analog and digital circuits, and/or one or more processors configured with software and/or firmware, e.g., stored in memory, that, when executed by the one or more processors such as the processor 1206, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1201-1205 described above may be a processor 1206 of the first node 111, or may be implemented as one or more applications running on one or more processors such as the processor 1206.

Thus, the methods according to the embodiments described herein for the first node 111 may be respectively implemented by means of a computer program 1210 product, comprising instructions, i.e., software code portions, which, when executed on at least one processor 1206, cause the at least one processor 1206 to carry out the actions described herein, as performed by the first node 111. The computer program 1210 product may be stored on a computer-readable storage medium 1211. The computer-readable storage medium 1211, having stored thereon the computer program 1210, may comprise instructions which, when executed on at least one processor 1206, cause the at least one processor 1206 to carry out the actions described herein, as performed by the first node 111. In some embodiments, the computer-readable storage medium 1211 may be a non-transitory computer-readable storage medium, such as a CD ROM disc, or a memory stick. In other embodiments, the computer program 1210 product may be stored on a carrier containing the computer program 1210 just described, wherein the carrier is one of an electronic signal, optical signal, radio signal, or the computer-readable storage medium 1211, as described above.

The first node 111 may comprise a communication interface configured to facilitate communications between the first node 111 and other nodes or devices, e.g., any of the second node 112, the third node 113, the one or more fourth nodes 114, the one or more fifth nodes 115, the one or more sixth nodes 116, the one or more devices 130 served directly by the third node 113, the host computer 1510, and/or any of the other nodes or devices. The interface may, for example, include a transceiver configured to transmit and receive radio signals over an air interface in accordance with a suitable standard.

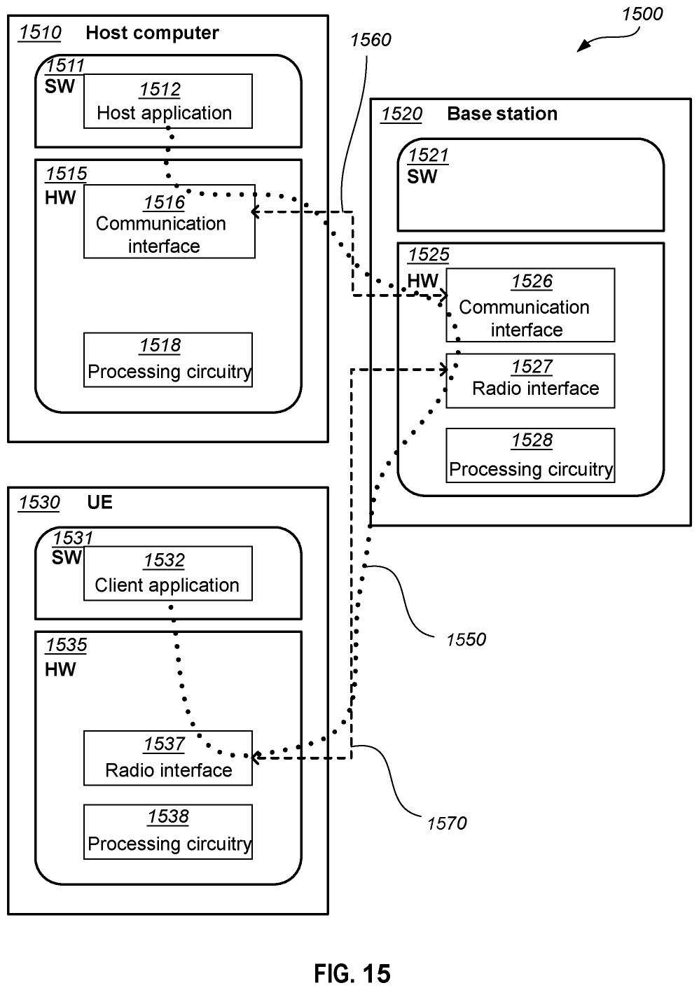

In other embodiments, the first node 111 may comprise the following arrangement depicted in FIG. 12b. The first node 111 may comprise a processing circuitry 1206, e.g., one or more processors such as the processor 1206, in the first node 111 and the memory 1207. The first node 111 may also comprise a radio circuitry 1212, which may comprise e.g., the receiving port 1208 and the sending port 1209. The processing circuitry 1206 may be configured to, or operable to, perform the method actions according to FIG. 10 and/or FIGS. 15-19, in a similar manner as that described in relation to FIG. 12a. The radio circuitry 1212 may be configured to set up and maintain at least a wireless connection with any of the second node 112, the third node 113, the one or more fourth nodes 114, the one or more fifth nodes 115, the one or more sixth nodes 116, the one or more devices 130 served directly by the third node 113, the host computer 1510, and/or any of the other nodes or devices. Circuitry may be understood herein as a hardware component.

Hence, embodiments herein also relate to the first node 111 operative to operate in the communications network 100. The first node 111 may comprise the processing circuitry 1206 and the memory 1207, said memory 1207 containing instructions executable by said processing circuitry 1206, whereby the first node 111 is further operative to perform the actions described herein in relation to the first node 111, e.g., in FIG. 10 and/or FIGS. 15-19.

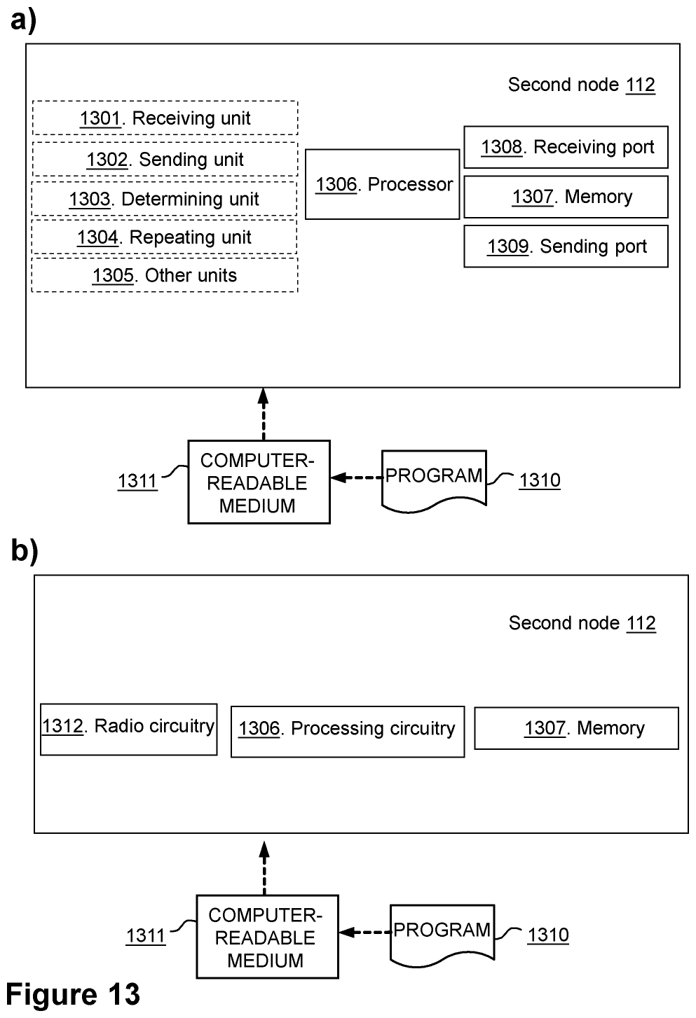

FIG. 13 depicts two different examples in panels a) and b), respectively, of the arrangement that the second node 112 may comprise. In some embodiments, the second node 112 may comprise the following arrangement depicted in FIG. 13a. The second node 112 may be understood to be for handling migration of a node. The second node 112 is configured to operate in the communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112, and will thus not be repeated here. For example, in some embodiments, wherein the communications network 100 may be configured to be an IAB network, the first node 111 may be configured to be a source CU, the second node 112 may be configured to be a target CU, and the third node 113 may be configured to be a top-level IAB node.

In FIG. 13, optional units are indicated with dashed boxes.

The second node 112 may be configured to perform the receiving of Action 1102 action, e.g. by means of a receiving unit 1301 within the second node 112 configured to, receive the indication from the first node 111 configured to be comprised in the communications network 100. The indication is configured to indicate the context of the third node 113, configured to be comprised in the communications network 100, to be migrated from the first node 111 to the second node 112. The context is configured to be for control of radio resource. The content of the indication is configured to be based on whether the migration of the third node 113 is to be partial or full. The receiving of the indication is configured to be performed in response to the first indication configured to be sent by the second node 112. The first indication is configured to request the context of the third node 113 from the first node 111.

In some embodiments, in partial migration, the mobile termination of the third node 113 may be configured to migrate to the second node 112, while the F1 and (RRC) connections of its collocated DU and all descendant mobile terminations and Distributed Units and devices 130, 140 configured to be served directly or indirectly by the third node 113, may be configured to remain anchored at the first node 111. In some embodiments, in full migration, all the F1 and RRC connections of the third node 113 and all its descendants 115 and devices 130, 140 configured to be served directly or indirectly by the third node 113, may be configured to migrate to the second node 112.

In some embodiments, at least one of the following may apply. According to the first group of embodiments, with the proviso that the migration is to be partial, the indication may be configured to further indicate one or more of: i) the one or more properties of ingress and egress BH RLC channels of the third node 113, ii) the number of descendants 115 of the third node 113, iii) the respective address of the descendants 115 of the third node 113, iv) the information on the topology of the branch of the communications network 100 wherein the third node 113 may be located, v) the first explicit indication that partial migration is requested, and vi) a respective number and type of IP addresses configured to be assigned to each of the descendants 115 of the third node 113 and the third node 113. According to the second group of embodiments, with the proviso that the migration is to be full, the indication may be further configured to indicate one or more of: i) the one or more properties of ingress and egress BH RLC channels of the third node 113, ii) the number of descendants 115 of the third node 113, iii) the respective address the descendants 115 of the third node 113, iv) the information on the topology of the branch of the communications network 100 wherein the third node 113 may be configured to be located, v) the first respective context for control of radio resource for the descendants 115 of the third node 113, vi) the respective one or more properties of ingress and egress BH RLC channels of the descendants 115 of the third node 113, vii) the respective routing information for the descendants 115 of the third node 113, viii) the respective number of descendants of the descendants 115 of the third node 113, ix) the respective number of parents of the descendants of the third node 113, x) the respective number of devices 140 configured to be served by the descendants 115 of the third node 113, xi) the respective list of one or more first cells 121 configured to be served by the descendants 115 of the third node 113, xii) the second respective context for control of radio resource for the devices 130, 140 configured to be served directly or indirectly by the third node 113, xiii) the one or more respective properties of radio bearers of the devices configured to be served directly or indirectly by the third node 113, xiv) the respective information of one or more flows of the devices 130, 140 configured to be served directly or indirectly by the third node 113, xv) the respective topology information for the devices 130, 140 configured to be served directly or indirectly by the third node 113, xvi) the second explicit indication that full migration is requested, and xvii) respective BAP address, and/or a respective number and type of IP addresses configured to be assigned to each node to be migrated.

In some embodiments, the context may be configured to be an RRC context.

In some embodiments, the indication may be configured to be the second indication and the second node 112 may be further configured to perform the sending of Action 1101, e.g., by means of a sending unit 1302 configured to, send the first indication to the first node 111.

In some embodiments, the first indication may be further configured to indicate whether or not the second node 112 may be able to accept a full migration or a partial migration.

The second node 112 may be further configured to perform the determining of Action 1103, e.g., by means of a determining unit 1303 within the second node 112 configured to, determine whether or not the migration is accepted, or whether or not to modify the migration. The determining may be configured to be based on the indication configured to be received.

In some embodiments, the determining may be configured to be based on at least one of: a) the load of one or more of: the second node 112, the one or more ancestors 116 configured to be served by the second node 112, the one or more second cells 122 of the ancestors 116, the one or more descendants 115 of the third node 113, the devices 130, 140 configured to be served directly or indirectly by the third node 113, and the one or more third devices 150 configured to be served by the descendants or the ancestors 116 configured to be served by the second node 112, and b) the one or more QoS properties of one or more of: the channels, the bearers and the priorities configured to be indicated in the indication configured to be received.

In some embodiments, the indication may be configured to be the second indication and the second node 112 may be further configured to perform the sending of Action 1104, e.g., by means of the sending unit 1302 configured to, send the third indication to the first node 111. The third indication may be configured to indicate whether or not the migration is accepted, or whether or not to modify the migration. The sending of the third indication may be configured to be based on the third result of the determining.

In some embodiments, the first indication may be configured to be a UE Context Retrieve Request and the second indication may be configured to be a UE Context Retrieve Response.

In some embodiments, the indication may be configured to be the second indication and the second node 112 may be further configured to perform the repeating of Action 1105, e.g. by means of a repeating unit 1304 within the second node 112 configured to, repeat the receiving of the of the second indication, the determining of whether or not the migration is accepted, or whether or not to modify the migration, and the sending of the third indication. The repeating may be based on the third result of the determination of whether or not to modify the migration.

In some embodiments, the indication may be configured to be the second indication and, with the proviso that the migration is accepted, the second node 112 may be further configured to perform the sending of Action 1106, e.g. by means of the sending unit 1302 within the second node 112 configured to, send the fifth indication, wherein, a) with the proviso that the migration is partial, the fifth indication may be configured to be sent to the third node 113, and the fifth indication may be configured to indicate: i) the information for radio resource control; and b) with the proviso that the migration is full, the fifth indication may be configured to indicate one or more of: i) the information for radio resource control, and the fifth indication may be configured to be sent to one or more of: the third node 113, one or more descendants 115 of the third node 113, and devices 130, 140 configured to be served directly or indirectly by the third node 113, and ii) the updated F1 configuration, and the fifth indication may be configured to be sent to one or more of: the third node 113, and one or more descendants 115 of the third node 113.

Other units 1305 may be comprised in the second node 112.

The embodiments herein in the second node 112 may be implemented through one or more processors, such as a processor 1306 in the second node 112 depicted in FIG. 13a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1307 comprising one or more memory units. The memory 1307 is arranged to be used to store obtained information, store data, configurations, schedulings, and applications etc. to perform the methods herein when being executed in the second node 112.

In some embodiments, the second node 112 may receive information from, e.g., any of the first node 111, the third node 113, the one or more fourth nodes 114, the one or more fifth nodes 115, the one or more sixth nodes 116, the one or more devices 130 served directly by the third node 113, the host computer 1510, and/or any of the other nodes or devices, through a receiving port 1308. In some embodiments, the receiving port 1308 may be, for example, connected to one or more antennas in the second node 112. In other embodiments, the second node 112 may receive information from another structure in the communications network 100 through the receiving port 1308. Since the receiving port 1308 may be in communication with the processor 1306, the receiving port 1308 may then send the received information to the processor 1306. The receiving port 1308 may also be configured to receive other information.

The processor 1306 in the second node 112 may be further configured to transmit or send information to e.g., any of the first node 111, the third node 113, the one or more fourth nodes 114, the one or more fifth nodes 115, the one or more sixth nodes 116, the one or more devices 130 served directly by the third node 113, the host computer 1510, and/or any of the other nodes or devices, or another structure in the communications network 100, through a sending port 1309, which may be in communication with the processor 1306, and the memory 1307.

Those skilled in the art will also appreciate that the units 1301-1305 described above may refer to a combination of analog and digital circuits, and/or one or more processors configured with software and/or firmware, e.g., stored in memory, that, when executed by the one or more processors such as the processor 1306, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1301-1305 described above implemented as a processor, such as the processor 1306, or as one or more applications running on one or more processors such as the processor 1306.

Thus, the methods according to the embodiments described herein for the second node 112 may be respectively implemented by means of a computer program 1310 product, comprising instructions, i.e., software code portions, which, when executed on at least one processor 1306, cause the at least one processor 1306 to carry out the actions described herein, as performed by the second node 112. The computer program 1310 product may be stored on a computer-readable storage medium 1311. The computer-readable storage medium 1311, having stored thereon the computer program 1310, may comprise instructions which, when executed on at least one processor 1306, cause the at least one processor 1306 to carry out the actions described herein, as performed by the second node 112. In some embodiments, the computer-readable storage medium 1311 may be a non-transitory computer-readable storage medium, such as a CD ROM disc, or a memory stick. In other embodiments, the computer program 1310 product may be stored on a carrier containing the computer program 1310 just described, wherein the carrier is one of an electronic signal, optical signal, radio signal, or the computer-readable storage medium 1311, as described above.

The second node 112 may comprise a communication interface configured to facilitate communications between the second node 112 and other nodes or devices, e.g., any of the first node 111, the third node 113, the one or more fourth nodes 114, the one or more fifth nodes 115, the one or more sixth nodes 116, the one or more devices 130 served directly by the third node 113, the host computer 1510, and/or any of the other nodes or devices. The interface may, for example, include a transceiver configured to transmit and receive radio signals over an air interface in accordance with a suitable standard.

In other embodiments, the second node 112 may comprise the following arrangement depicted in FIG. 13b. The second node 112 may comprise a processing circuitry 1306, e.g., one or more processors such as the processor 1306, in the second node 112 and the memory 1307. The second node 112 may also comprise a radio circuitry 1312, which may comprise e.g., the receiving port 1308 and the sending port 1309. The processing circuitry 1306 may be configured to, or operable to, perform the method actions according to FIG. 11 and/or FIGS. 15-19, in a similar manner as that described in relation to FIG. 13a. The radio circuitry 1312 may be configured to set up and maintain at least a wireless connection with any of the first node 111, the third node 113, the one or more fourth nodes 114, the one or more fifth nodes 115, the one or more sixth nodes 116, the one or more devices 130 served directly by the third node 113, the host computer 1510, and/or any of the other nodes or devices. Circuitry may be understood herein as a hardware component.

Hence, embodiments herein also relate to the second node 112 operative to operate in the communications network 100. The second node 112 may comprise the processing circuitry 1306 and the memory 1307, said memory 1307 containing instructions executable by said processing circuitry 1306, whereby the second node 112 is further operative to perform the actions described herein in relation to the second node 112, e.g., in FIG. 11 and/or FIGS. 15-19.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

When using the word “comprise” or “comprising” it shall be interpreted as non-limiting, i.e. meaning “consist at least of”.

A processor may be understood herein as a hardware component.

The embodiments herein are not limited to the above described preferred embodiments. Various alternatives, modifications and equivalents may be used. Therefore, the above embodiments should not be taken as limiting the scope of the invention.

### Examples of, or Related to, Embodiments Herein

Examples related to embodiments herein may be as follows.

The first node 111 examples relate to FIG. 10, FIG. 12 and Figures QQ4-QQ9. A method, performed by a node, such as the first node 111 is described herein. The method may be understood to be for handling migration of a node, such as the third node 113, e.g., a top end node or top-level node. The first node 111 may operate in the communications network 100.

The communications network 100 may be a multi-hop deployment. In some examples, the communications network 100 may be an Integrated Access Backhaul (IAB) network.

The method may comprise one or more of the following actions.

In some examples all the actions may be performed. In other examples, one or more actions may be performed. One or more examples may be combined, where applicable. All possible combinations are not described to simplify the description. Some actions may be performed in a different order than that shown in FIG. 10. In FIG. 10, actions which may be optional in some examples are depicted with dashed boxes.
Sending 1003 an indication, which may be referred to later as a “second indication”. The first node 111 may be configured to perform the sending in this Action 1003 action, e.g. by means of a sending unit 1201 within the first node 111, configured to perform this action.

The first node 111 may send the indication to the second node 112 comprised in the communications network 100.

The indication may indicate a context of the third node 113 comprised in the communications network 100.

The third node 113 may be to be migrated from the first node 111 to the second node 112.

The context may be for control of radio resource.

A content of the indication may be based on whether the migration of the third node 113 is to be partial or full.

The sending 1003 of the indication may be performed in response to a first indication received from the second node 112. The first indication may request the context of the third node 113 from the first node 111.

In some examples, the context may be an RRC context.

In some examples, the first indication may be a UE Context Retrieve Request and the second indication may be a UE Context Retrieve Response.

In general terms, in some examples, with the proviso that the migration is to be partial, the indication may indicate first information pertaining to the third node 113. With the proviso that the migration is to be full, the indication may indicate the first information pertaining to the third node 113 and second information pertaining to the descendants 115 of the third node 113, and/or any, or all, of the devices 130, 140 served directly or indirectly by the third node 11.

In some examples, at least one of the following may apply:
with the proviso that the migration is to be partial, the indication may further indicate one or more of:
   i. one or more properties of ingress and egress BackHaul Radio Link Control, BH RLC, channels of the third node 113,
   ii. a number of descendants 115 of the third node 113,
   iii. a respective address the descendants 115 of the third node 113,
   iv. information on a topology of a branch of the communications network 100 wherein the third node 113 is located, and
   v. a first explicit indication that partial migration is requested, and
with the proviso that the migration is to be full, the indication may further indicate one or more of:
   i. the one or more properties of ingress and egress BackHaul Radio Link Control, BH RLC, channels of the third node 113,
   ii. the number of descendants 115 of the third node 113,
   iii. the respective address the descendants 115 of the third node 113,
   iv. the information on the topology of the branch of the communications network 100 wherein the third node 113 is located,
   v. a first respective context for control of radio resource for the descendants 115 of the third node 113,
   vi. respective one or more properties of ingress and egress BackHaul Radio Link Control, BH RLC, channels of the descendants 115 of the third node 113,
   vii. a respective routing information for the descendants 115 of the third node 113,
   viii. a respective number of descendants of the descendants 115 of the third node 113,
   ix. a respective number of parents of the descendants of the third node
   x. a respective number of devices 140 served by the descendants 115 of the third node 113,
   xi. a respective list of one or more first cells 121 served by the descendants 115 of the third node 113,
   xii. a second respective context for control of radio resource for the devices 130, 140 served directly or indirectly by the third node 113,
   xiii. one or more respective properties of radio bearers of the devices served directly or indirectly by the third node 113,
   xiv. respective information of one or more flows of the devices 130, 140 served directly or indirectly by the third node 113,
   xv. respective topology information for the devices 130, 140 served directly or indirectly by the third node 113, and
   xvi. a second explicit indication that full migration is requested.

In some examples, the method may comprise one or more of the following actions:
Determining 1002 whether the indication is to be for a partial migration or a full migration. The first node 111 may be configured to perform the determining of this Action 1002, e.g. by means of a determining unit 1202 within the first node 111, configured to perform this action.

Determining may be understood as calculating, or deriving.

The sent indication may be based on a first result of the determination.

In some examples, the determining 1002 may be based on at least one of:
one or more measurements, e.g., between the third node 113 and one or more fourth nodes 114, e.g., parent nodes, or potential parent nodes of the third node 113,
whether or not the third node 113 is a mobile node,
a number of failures experienced by the third node 113 with any parent node 114 of the third node 113,
one or more indications received from the second node 112, e.g., a first indication received from the second node 112, and
a load of the first node 111.

In some examples, the indication may be a second indication.
Receiving 1001 the first indication. The first node 111 may be configured to perform the receiving of this Action 1001, e.g. by means of a receiving unit 1203 within the first node 111, configured to perform this action.

The first indication may be received from the second node 112.
Receiving 1004 a third indication. The first node 111 may be configured to perform the receiving of this Action 1004, e.g. by means of the receiving unit 1203 within the first node 111, configured to perform this action.

The third indication may be received from the second node 112.

The third indication may indicate whether or not the migration is accepted. The receiving in this Action 1004 of the third indication may be based on the sent second indication.
Determining 1005 whether or not to modify the migration n. The first node 111 may be configured to perform the determining of this Action 1005, e.g. by means of the determining unit 1202 within the first node 111, configured to perform this action.

In some examples, the determining in this Action 1005 may be based on the received third indication.
Repeating 1006 one or more of: the sending of the 1003 of the indication, the receiving 1004 of the third indication, and the determining 1005 of whether or not to modify the migration. The first node 111 may be configured to perform the receiving of this Action 1001, e.g. by means of a receiving unit 1203 within the first node 111, configured to perform this action.

The repeating in this Action 1006 may be based a second result of the determination of whether or not to modify the migration.
Sending 1007 a fourth indication. The first node 111 may be configured to perform the sending in this Action 1003 action, e.g. by means of a sending unit 1201 within the first node 111, configured to perform this action.

The sending in this Action 1007 may be performed in examples wherein the migration is to be partial.

The first node 111 may send the fourth indication to the to the third node 113. The fourth indication may indicate an F1 configuration update.

In some examples, wherein the communications network 100 is an Integrated Access and Backhaul (IAB) network, the first node 111 may be a source Centralized Unit (CU), the second node 112 may be a target CU, and the third node 113 may be a top-level IAB node.

Other units 1205 may be comprised in the first node 111.

The first node 111 may also be configured to communicate user data with a host application unit in a host computer QQ510, e.g., via another link such as QQ550.

In FIG. 12, optional units are indicated with dashed boxes.

The first node 111 may comprise an interface unit to facilitate communications between the first node 111 and other nodes or devices, e.g., any of the second node 112, the third node 113, the one or more fourth nodes 114, the one or more fifth nodes 115, the one or more sixth nodes 116, the one or more devices 130 served directly by the third node 113, the host computer QQ510, and/or any of the other nodes or devices. In some particular examples, the interface may, for example, include a transceiver configured to transmit and receive radio signals over an air interface in accordance with a suitable standard.

The first node 111 may comprise an arrangement as shown in FIG. 12 or in Figure QQ5.

The second node 112 examples relate to FIG. 11, FIG. 13 and Figures QQ4-QQ9.

A method performed by another node, such as the second node 112 is described herein. The method may be understood to be for handling migration of the node. The second node 112 may operate in the communications network 100.

The communications network 100 may be a multi-hop deployment. In some examples, the communications network 100 may be an Integrated Access Backhaul (IAB) network.

The method may comprise one or more of the following actions.

In some examples all the actions may be performed. In other examples, one or more actions may be performed. One or more examples may be combined, where applicable. All possible combinations are not described to simplify the description. Some actions may be performed in a different order than that shown in FIG. 11. In FIG. 11, actions which may be optional in some examples are depicted with dashed boxes.
Receiving 1102 the indication, e.g., also referred to herein as the second indication. The second node 112 may be configured to perform the receiving in this Action 1102 action, e.g. by means of a receiving unit 1301 within the second node 112, configured to perform this action.

The second node 112 may receive the indication from the first node 111 comprised in the communications network 100.

The indication may indicate a context of the third node 113 comprised in the communications network 100.

The third node 113 may be to be migrated from the first node 111 to the second node 112.

The context may be for control of radio resource.

The content of the indication may be based on whether the migration of the third node 113 is to be partial or full.

The receiving 1102 of the indication may be performed in response to a first indication sent by the second node 112. The first indication may request the context of the third node 113 from the first node 111.

In some examples, the context may be the RRC context.

In some examples, the first indication may be a UE Context Retrieve Request and the second indication may be a UE Context Retrieve Response.

In general terms, in some examples, with the proviso that the migration is to be partial, the indication may indicate first information pertaining to the third node 113. With the proviso that the migration is to be full, the indication may indicate the first information pertaining to the third node 113 and second information pertaining to the descendants 115 of the third node 113, and/or any, or all, of the devices 130, 140 served directly or indirectly by the third node 11.

In some examples, at least one of the following may apply:
with the proviso that the migration is to be partial, the indication may further indicate one or more of:
   i. the one or more properties of ingress and egress BackHaul Radio Link Control, BH RLC, channels of the third node 113,
   ii. the number of descendants 115 of the third node 113,
   iii. the respective address the descendants 115 of the third node 113,
   iv. the information on the topology of the branch of the communications network 100 wherein the third node 113 is located, and
   v. the first explicit indication that partial migration is requested, and
with the proviso that the migration is to be full, the indication may further indicate one or more of:
   i. the one or more properties of ingress and egress BackHaul Radio Link Control, BH RLC, channels of the third node 113,
   ii. the number of descendants 115 of the third node 113,
   iii. the respective address the descendants 115 of the third node 113,
   iv. the information on the topology of the branch of the communications network 100 wherein the third node 113 is located,
   v. the first respective context for control of radio resource for the descendants 115 of the third node 113,
   vi. the respective one or more properties of ingress and egress BackHaul Radio Link Control, BH RLC, channels of the descendants 115 of the third node 113,
   vii. the respective routing information for the descendants 115 of the third node 113,
   viii. the respective number of descendants of the descendants 115 of the third node 113,
   ix. the respective number of parents of the descendants of the third node 113,
   x. the respective number of devices 140 served by the descendants 115 of the third node 113,
   xi. the respective list of one or more first cells 121 served by the descendants 115 of the third node 113,
   xii. the second respective context for control of radio resource for the devices 130, 140 served directly or indirectly by the third node 113,
   xiii. the one or more respective properties of the radio bearers of the devices served directly or indirectly by the third node 113,
   xiv. the respective information of the one or more flows of the devices 130, 140 served directly or indirectly by the third node 113,
   xv. the respective topology information for the devices 130, 140 served directly or indirectly by the third node 113, and
   xvi. the second explicit indication that full migration is requested.

In some examples, the method may comprise one or more of the following actions:

In some examples, the indication may be a second indication.
Sending 1101 the first indication. The second node 112 may be configured to perform the sending of this Action 1101, e.g., by means of a sending unit 1302, configured to perform this action.

The sending in this Action 1101 may be to the first node 111.

The first indication may further indicate, e.g., based on one or more conditions or capabilities, whether or not the second node 112 may be able to accept a full migration or a partial migration.
Determining 1103 whether or not the migration is accepted, or whether or not to modify the migration. The second node 112 may be configured to perform the determining of this Action 1103, e.g., by means of a determining unit 1303 within the second node 112, configured to perform this action.

The determining 1103 may be based on the received indication, that is, the second indication.

In some examples, the determining 1103 may be based on at least one of::
a load of one or more of: the second node 112, one or more ancestors 116 served by the second node 112, one or more second cells 122 of the ancestors 116, one or more descendants 115 of the third node 113, devices 130, 140 served directly or indirectly by the third node 113, and one or more devices 150 served by the descendants or the ancestors 116 of, that is, served by, the second node 112, and
one or more quality of service (QOS) properties of one or more of: channels, bearers and priorities indicated in the received indication.
   Sending 1104 the third indication. The second node 112 may be configured to perform this obtaining 804 action, e.g., by means of the obtaining unit 1301, configured to perform this action.

The third indication may be sent to the first node 111.

The third indication may indicate whether or not the migration is accepted, or whether or not to modify the migration. The sending in this Action 1104 of the third indication may be based on a third result of the determining performed in Action 1103.
Repeating 1105 one or more of: the receiving of the 1102 of the second indication, the determining 1103 of whether or not the migration is accepted, or whether or not to modify the migration, and the sending 1104 of the third indication. The second node 112 may be configured to perform the repeating of this Action 1105, e.g. by means of a repeating unit 1304 within the second node 112, configured to perform this action.

The repeating in this Action 1105 may be based a third result of the determination of whether or not to modify the migration.
Sending 1106 a fifth indication. The first node 111 may be configured to perform the sending in this Action 1106 action, e.g. by means of the sending unit 1302 within the second node 112, configured to perform this action.

The sending in this Action 1106 may be performed in with the proviso that the migration is accepted.

In some examples, a) with the proviso that the migration is partial, the fifth indication may be sent to the third node 113. The fifth indication may indicate:
i. information for radio resource control.

In some examples, b) with the proviso that the migration is full, the fifth indication may indicate one or more of:
ii. the information for radio resource control; in these examples, the fifth indication may be sent to one or more of: the third node 113, one or more descendants 115 of the third node 113, and devices 130, 140 served directly or indirectly by the third node 113, and
iii. an updated F1 configuration; in these examples, the fifth indication may be sent to one or more of: the third node 113, one or more descendants 115 of the third node 113.

In some examples, wherein the communications network 100 may be an Integrated Access and Backhaul (IAB) network, the first node 111 may be a source Centralized Unit (CU), the second node 112 may be a target CU, and the third node 113 may be a top-level IAB node.

Other units 1305 may be comprised in the second node 112.

The second node 112 may also be configured to communicate user data with a host application unit in a host computer QQ510, e.g., via another link such as QQ550.

In FIG. 13, optional units are indicated with dashed boxes.

The second node 112 may comprise an interface unit to facilitate communications between the second node 112 and other nodes or devices, e.g., any of the first node 111, the third node 113, the one or more fourth nodes 114, the one or more fifth nodes 115, the one or more sixth nodes 116, the one or more devices 130 served directly by the third node 113, the host computer QQ510, and/or any of the other nodes or devices, the host computer QQ510, or any of the other nodes. In some particular examples, the interface may, for example, include a transceiver configured to transmit and receive radio signals over an air interface in accordance with a suitable standard.

The second node 112 may comprise an arrangement as shown in FIG. 13 or in Figure QQ5.

Example 1. A method performed by a first node (111), the method being for handling migration of a node, the first node (111) operating in a communications network (100), the method comprising:
sending (1003) an indication to a second node (112) comprised in the communications network (100), the indication indicating a context of a third node (113) comprised in the communications network (100) to be migrated from the first node (111) to the second node (112), the context being for control of radio resource, wherein a content of the indication is based on whether the migration of the third node (113) is to be partial or full, and wherein the sending (1003) of the indication is performed in response to a first indication received from the second node (112), the first indication requesting the context of the third node (113) from the first node (111).

Example 2. The method according to example 1, wherein at least one of:
with the proviso that the migration is to be partial, the indication further indicates one or more of:
   i. one or more properties of ingress and egress BackHaul Radio Link Control, BH RLC, channels of the third node (113),
   ii. a number of descendants (115) of the third node (113),
   iii. a respective address the descendants (115) of the third node (113),
   iv. information on a topology of a branch of the communications network (100) wherein the third node (113) is located, and
   v. a first explicit indication that partial migration is requested, and
with the proviso that the migration is to be full, the indication further indicates one or more of:
   i. one or more properties of ingress and egress BackHaul Radio Link Control, BH RLC, channels of the third node (113),
   ii. a number of descendants (115) of the third node (113),
   iii. a respective address the descendants (115) of the third node (113),
   iv. information on a topology of a branch of the communications network (100) wherein the third node (113) is located,
   v. a first respective context for control of radio resource for the descendants (115) of the third node (113),
   vi. respective one or more properties of ingress and egress BackHaul Radio Link Control, BH RLC, channels of the descendants (115) of the third node (113),
   vii. a respective routing information for the descendants (115) of the third node (113),
   viii. a respective number of descendants of the descendants (115) of the third node (113),
   ix. a respective number of parents of the descendants of the third node (113),
   x. a respective number of devices (140) served by the descendants (115) of the third node (113),
   xi. a respective list of one or more first cells (121) served by the descendants (115) of the third node (113),
   xii. a second respective context for control of radio resource for the devices (130, 140) served directly or indirectly by the third node (113),
   xiii. one or more respective properties of radio bearers of the devices served directly or indirectly by the third node (113),
   xiv. respective information of one or more flows of the devices (130, 140) served directly or indirectly by the third node (113),
   xv. respective topology information for the devices (130, 140) served directly or indirectly by the third node (113), and
   xvi. a second explicit indication that full migration is requested.

Example 3. The method according to example any of examples 1-2, wherein the context is a Radio Resource Control, RRC, context.

Example 4. The method according to any of examples 1-3, further comprising:
determining (1002) whether the indication is to be for a partial migration or a full migration, and wherein the sent indication is based on a first result of the determination.

Example 5. The method according to example 4, wherein the determining (1002) is based on at least one of:
one or more measurements, e.g., between the third node (113) and one or more fourth nodes (114),
whether or not the third node (113) is a mobile node,
a number of failures experienced by the third node (113) with any parent node (114) of the third node (113),
one or more indications received from the second node (112), e.g., a first indication received from the second node (112), and
a load of the first node (111).

Example 6. The method according to any of examples 1-5, wherein the indication is a second indication and wherein the method further comprises:
receiving (1001) the first indication from the second node (112).

Example 7. The method according to example 6, wherein the first indication is a UE Context Retrieve Request and the second indication is a UE Context Retrieve Response.

Example 8. The method according to any of examples 1-7, wherein the indication is a second indication and wherein the method further comprises:
receiving (1004) a third indication from the second node (112), the third indication indicating whether or not the migration is accepted, wherein the receiving (1004) of the third indication is based on the sent second indication.

Example 9. The method according to example 8, further comprising:
determining (1005) whether or not to modify the migration based on the received third indication, and
repeating (1006) the sending of the (1003) of the indication, the receiving (1004) of the third indication, and the determining (1005) of whether or not to modify the migration, based a second result of the determination of whether or not to modify the migration.

Example 10. The method according to any of examples 1-9, wherein the indication is a second indication, and wherein the migration is to be partial, and wherein the method further comprises:
sending (1007) a fourth indication to the third node (113), the fourth indication indicating an F1 configuration update.

Example 11. The method according to any of examples 1-10, wherein the communications network (100) is an Integrated Access and Backhaul, IAB, network, and wherein the first node (111) is a source Centralized Unit, CU, the second node (112) is a target CU, and the third node (113) is a top-level IAB node.

Example 12. A method performed by a second node (112), the method being for handling migration of a node, the second node (112) operating in a communications network (100), the method comprising:
receiving (1102) an indication from a first node (111) comprised in the communications network (100), the indication indicating a context of a third node (113) comprised in the communications network (100) to be migrated from the first node (111) to the second node (112), the context being for control of radio resource, wherein a content of the indication is based on whether the migration of the third node (113) is to be partial or full, and wherein the receiving (1102) of the indication is performed in response to a first indication sent by the second node (112), the first indication requesting the context of the third node (113) from the first node (111).

Example 13. The method according to example 12, wherein at least one of:
with the proviso that the migration is to be partial, the indication further indicates one or more of:
   i. one or more properties of ingress and egress BackHaul Radio Link Control, BH RLC, channels of the third node (113),
   ii. a number of descendants (115) of the third node (113),
   iii. a respective address the descendants (115) of the third node (113),
   iv. information on a topology of a branch of the communications network (100) wherein the third node (113) is located, and
   v. a first explicit indication that partial migration is requested, and
with the proviso that the migration is to be full, the indication further indicates one or more of:
   i. one or more properties of ingress and egress BackHaul Radio Link Control, BH RLC, channels of the third node (113),
   ii. a number of descendants (115) of the third node (113),
   iii. a respective address the descendants (115) of the third node (113),
   iv. information on a topology of a branch of the communications network (100) wherein the third node (113) is located,
   v. a first respective context for control of radio resource for the descendants (115) of the third node (113),
   vi. respective one or more properties of ingress and egress BackHaul Radio Link Control, BH RLC, channels of the descendants (115) of the third node (113),
   vii. a respective routing information for the descendants (115) of the third node (113),
   viii. a respective number of descendants of the descendants (115) of the third node (113),
   ix. a respective number of parents of the descendants of the third node (113),
   x. a respective number of devices (140) served by the descendants (115) of the third node (113),
   xi. a respective list of one or more first cells (121) served by the descendants (115) of the third node (113),
   xii. a second respective context for control of radio resource for the devices (130, 140) served directly or indirectly by the third node (113),
   xiii. one or more respective properties of radio bearers of the devices served directly or indirectly by the third node (113),
   xiv. respective information of one or more flows of the devices (130, 140) served directly or indirectly by the third node (113),
   xv. respective topology information for the devices (130, 140) served directly or indirectly by the third node (113), and
   xvi. a second explicit indication that full migration is requested.

Example 14. The method according to example any of examples 12-13, wherein the context is a Radio Resource Control, RRC, context.

Example 15. The method according to any of examples 12-14, wherein the indication is a second indication and wherein the method further comprises:
sending (1101) the first indication to the first node (111).

Example 16. The method according to example 15, wherein the first indication further indicates, e.g., based on one or more conditions or capabilities, whether or not the second node (112) is able to accept a full migration or a partial migration.

Example 17. The method according to any of examples 12-16, further comprising:
determining (1103) whether or not the migration is accepted, or whether or not to modify the migration, wherein the determining (1103) is based on the received indication.

Example 18. The method according to example 17, wherein the determining (1103) is based on at least one of:
a load of one or more of: the second node (112), one or more ancestors (116) served by the second node (112), one or more second cells (122) of the ancestors (116), one or more descendants (115) of the third node (113), devices (130, 140) served directly or indirectly by the third node (113), and one or more third devices (150) served by the descendants or the ancestors (116) of, that is, served by, the second node (112), and
one or more quality of service, QoS, properties of one or more of: channels, bearers and priorities indicated in the received indication.

Example 19. The method according to any of examples 17-18, wherein the indication is a second indication and wherein the method further comprises:
sending (1104) a third indication to the first node (111), the third indication indicating whether or not the migration is accepted, or whether or not to modify the migration, wherein the sending (1104) of the third indication is based on a third result of the determining (1103).

Example 20. The method according to example 19, wherein the first indication is a UE Context Retrieve Request and the second indication is a UE Context Retrieve Response.

Example 21. The method according to any of examples 1-9, wherein the indication is a second indication, and wherein the method further comprises:
repeating (1105) the receiving of the (1102) of the second indication, the determining (1103) of whether or not the migration is accepted, or whether or not to modify the migration, and the sending (1104) of the third indication, based on a third result of the determination of whether or not to modify the migration.

Example 22. The method according to any of examples 12-21, wherein the indication is a second indication, and wherein, with the proviso that the migration is accepted, the method further comprises:
sending (1106) a fifth indication, wherein,
   1. with the proviso that the migration is partial, the fifth indication is sent to the third node (113), and the fifth indication indicates:
      ii. information for radio resource control, and
   1. with the proviso that the migration is full, the fifth indication indicates one or more of:
      iii. the information for radio resource control, and the fifth indication is sent to one or more of: the third node (113), one or more descendants (115) of the third node (113), and devices (130, 140) served directly or indirectly by the third node (113), and
      iv. an updated F1 configuration, and the fifth indication is sent to one or more of: the third node (113), one or more descendants (115) of the third node (113).

Example 23. The method according to any of examples 12-22, wherein the communications network (100) is an Integrated Access and Backhaul, IAB, network, and wherein the first node (111) is a source Centralized Unit, CU, the second node (112) is a target CU, and the third node (113) is a top-level IAB node.

### Further Extensions and Variations

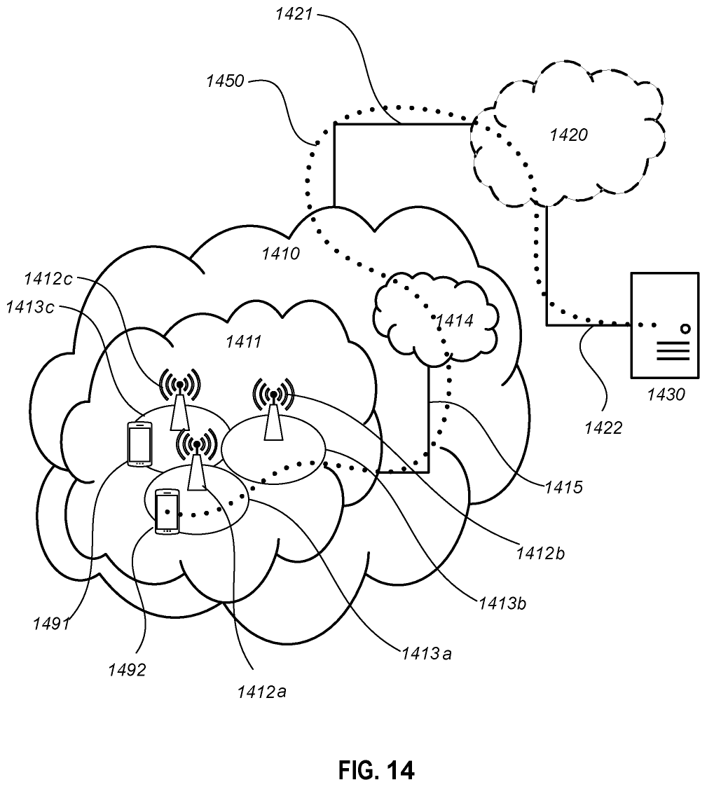

FIG. 14: Telecommunication Network Connected Via an Intermediate Network to a Host Computer in Accordance with Some Embodiments

With reference to FIG. 14, in accordance with an embodiment, a communication system includes telecommunication network 1410 such as the communications network 100, for example, a 3GPP-type cellular network, which comprises access network 1411, such as a radio access network, and core network 1414. Access network 1411 comprises a plurality of network nodes such as any of the first node 111, the second node 112, the third node 113, the one or more fourth nodes 114, the one or more fifth nodes 115, and/or the one or more sixth nodes 116. For example, base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. In FIG. 14, a first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412. Any of the UEs 1491, 1492 may be as examples of any of the one or more devices 130 served directly by the third node 113, the one or more devices 140 served by the descendants 115 of the third node 113 and/or the one or more devices 150 served by the descendants or the ancestors 116 served by the second node 112.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 14 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

In relation to FIGS. 15, 16, 17, 18, and 19, which are described next, it may be understood that a UE may be considered to, be an example of any of the one or more devices 130 served directly by the third node 113, the one or more devices 140 served by the descendants 115 of the third node 113 and/or the one or more devices 150 served by the descendants or the ancestors 116 served by the second node 112. It may be also understood that the base station is an example of any of the first node 111, the second node 112, the third node 113, the one or more fourth nodes 114, the one or more fifth nodes 115, and/or the one or more sixth nodes 116.

FIG. 15: Host Computer Communicating Via a Base Station with a User Equipment Over a Partially Wireless Connection in Accordance with Some Embodiments

Example implementations, in accordance with an embodiment, of any of the one or more devices 130 served directly by the third node 113, the one or more devices 140 served by the descendants 115 of the third node 113 and/or the one or more devices 150 served by the descendants or the ancestors 116 served by the second node 112, e.g., a UE, and any of the first node 111, the second node 112, the third node 113, the one or more fourth nodes 114, the one or more fifth nodes 115, and/or the one or more sixth nodes 116, e.g., a base station, and host computer discussed in the preceding paragraphs will now be described with reference to FIG. 15. In communication system 1500, such as the communications network 100, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes any of the first node 111, the second node 112, the third node 113, the one or more fourth nodes 114, the one or more fifth nodes 115, and/or the one or more sixth nodes 116, exemplified in FIG. 15 as a base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with any of the one or more devices 130 served directly by the third node 113, the one or more devices 140 served by the descendants 115 of the third node 113 and/or the one or more devices 150 served by the descendants or the ancestors 116 served by the second node 112, exemplified in FIG. 15 as a UE 1530 located in a coverage area (not shown in FIG. 15) served by base station 1520. Communication interface 1526 may be configured to facilitate connection 1560 to host computer 1510. Connection 1560 may be direct or it may pass through a core network (not shown in FIG. 15) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

The first node 111 embodiments relate to FIG. 10, FIG. 12 and FIGS. 14-19.

The first node 111 may also be configured to communicate user data with a host application unit in a host computer 1510, e.g., via another link such as 1550.

The first node 111 may comprise an interface unit to facilitate communications between the first node 111 and other nodes or devices, e.g., any of the second node 112, the third node 113, the one or more fourth nodes 114, the one or more fifth nodes 115, the one or more sixth nodes 116, the one or more devices 130 served directly by the third node 113, the host computer 1510, and/or any of the other nodes or devices. In some particular examples, the interface may, for example, include a transceiver configured to transmit and receive radio signals over an air interface in accordance with a suitable standard.

The first node 111 may comprise an arrangement as shown in FIG. 12 or in FIG. 15.

The second node 112 embodiments relate to FIG. 11, FIG. 13 and FIGS. 14-19.

The second node 112 may also be configured to communicate user data with a host application unit in a host computer 1510, e.g., via another link such as 1550.

The second node 112 may comprise an interface unit to facilitate communications between the second node 112 and other nodes or devices, e.g., any of the first node 111, the third node 113, the one or more fourth nodes 114, the one or more fifth nodes 115, the one or more sixth nodes 116, the one or more devices 130 served directly by the third node 113, the host computer 1510, and/or any of the other nodes or devices, the host computer 1510, or any of the other nodes. In some particular examples, the interface may, for example, include a transceiver configured to transmit and receive radio signals over an air interface in accordance with a suitable standard.

The second node 112 may comprise an arrangement as shown in FIG. 13 or in FIG. 15.

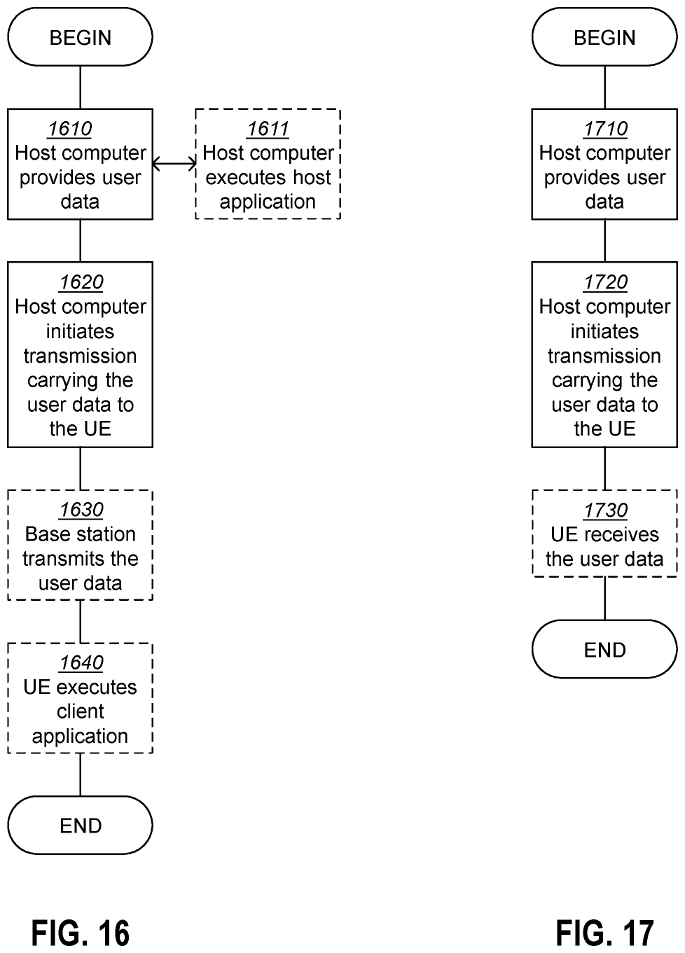

FIG. 16: Methods Implemented in a Communication System Including a Host Computer, a Base Station and a User Equipment in Accordance with Some Embodiments

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

FIG. 17: Methods Implemented in a Communication System Including a Host Computer, a Base Station and a User Equipment in Accordance with Some Embodiments

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

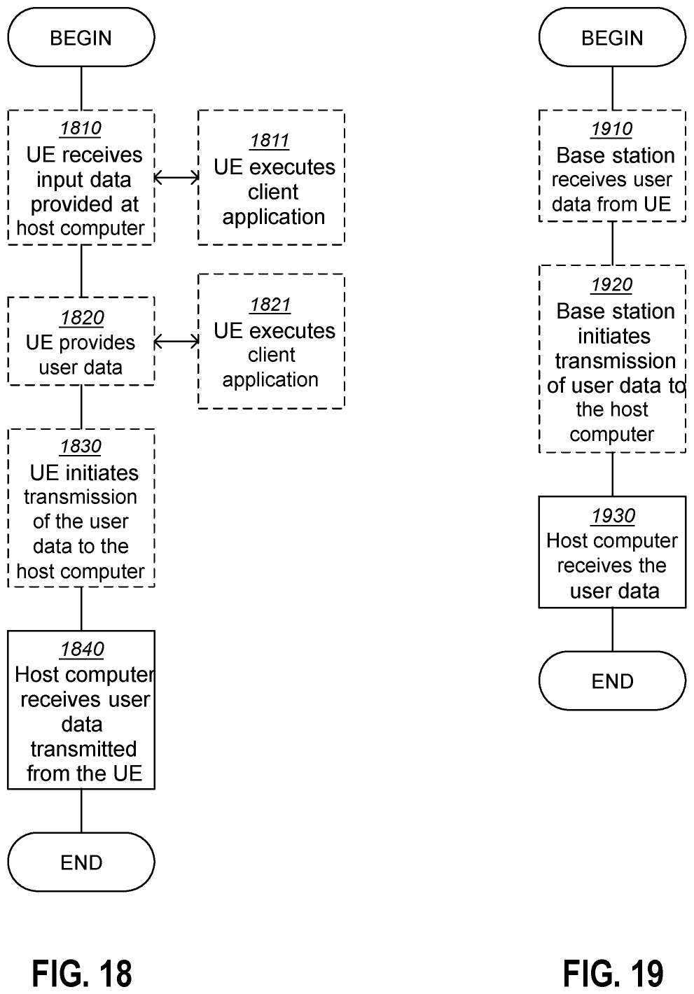

FIG. 18: Methods Implemented in a Communication System Including a Host Computer, a Base Station and a User Equipment in Accordance with Some Embodiments

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

FIG. 19: Methods Implemented in a Communication System Including a Host Computer, a Base Station and a User Equipment in Accordance with Some Embodiments

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by any of the first node 111 and/or the second node 112.
5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by any of the first node 111 and/or the second node 112.
   6. The communication system of embodiment 5, further including the base station.
   7. The communication system of embodiment 6, further including the UE, wherein the UE is configured to communicate with the base station.
   8. The communication system of embodiment 7, wherein:
the processing circuitry of the host computer is configured to execute a host application, thereby providing the user data; and
the UE comprises processing circuitry configured to execute a client application associated with the host application.
   11. A method implemented in a base station, comprising one or more of the actions described herein as performed by any of the first node 111 and/or the second node 112.
   15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by any of the first node 111 and/or the second node 112.
   16. The method of embodiment 15, further comprising:
at the base station, transmitting the user data.
   17. The method of embodiment 16, wherein the user data is provided at the host computer by executing a host application, the method further comprising:
at the UE, executing a client application associated with the host application.
   21. A user equipment (UE) configured to communicate with a base station, the UE comprising a radio interface and processing circuitry configured to perform one or more of the actions described herein as performed by the one or more devices 130.
   25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by the one or more devices 130.
   26. The communication system of embodiment 25, further including the UE.
   27. The communication system of embodiment 26, wherein the cellular network further includes a base station configured to communicate with the UE.
   28. The communication system of embodiment 26 or 27, wherein:
the processing circuitry of the host computer is configured to execute a host application, thereby providing the user data; and
the UE's processing circuitry is configured to execute a client application associated with the host application.
   31. A method implemented in a user equipment (UE), comprising one or more of the actions described herein as performed by the one or more devices 130.
   35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by the one or more devices 130.
   36. The method of embodiment 35, further comprising:
at the UE, receiving the user data from the base station.
   41. A user equipment (UE) configured to communicate with a base station, the UE comprising a radio interface and processing circuitry configured to perform one or more of the actions described herein as performed by the one or more devices 130.
   45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by the one or more devices 130.
   46. The communication system of embodiment 45, further including the UE.
   47. The communication system of embodiment 46, further including the base station, wherein the base station comprises a radio interface configured to communicate with the UE and a communication interface configured to forward to the host computer the user data carried by a transmission from the UE to the base station.
   48. The communication system of embodiment 46 or 47, wherein:
the processing circuitry of the host computer is configured to execute a host application; and
the UE's processing circuitry is configured to execute a client application associated with the host application, thereby providing the user data.
   49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.
   51. A method implemented in a user equipment (UE), comprising one or more of the actions described herein as performed by the one or more devices 130.
   52. The method of embodiment 51, further comprising:
providing user data; and
forwarding the user data to a host computer via the transmission to the base station.
   55. A method implemented in a communication system including a host computer, a base station and a user equipment (UE), the method comprising:
at the host computer, receiving user data transmitted to the base station from the UE, wherein the UE performs one or more of the actions described herein as performed by the one or more devices 130.
   56. The method of embodiment 55, further comprising:
at the UE, providing the user data to the base station.
   57. The method of embodiment 56, further comprising:
at the UE, executing a client application, thereby providing the user data to be transmitted; and
at the host computer, executing a host application associated with the client application.
   58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.
   61. A base station configured to communicate with a user equipment (UE), the base station comprising a radio interface and processing circuitry configured to perform one or more of the actions described herein as performed by any of the first node 111 and/or the second node 112.
   65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by any of the first node 111 and/or the second node 112.
   66. The communication system of embodiment 65, further including the base station.
   67. The communication system of embodiment 66, further including the UE, wherein the UE is configured to communicate with the base station.
   68. The communication system of embodiment 67, wherein:
the processing circuitry of the host computer is configured to execute a host application;
the UE is configured to execute a client application associated with the host application, thereby providing the user data to be received by the host computer.
   71. A method implemented in a base station, comprising one or more of the actions described herein as performed by any of the first node 111 and/or the second node 112.
   75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by the one or more devices 130.
   76. The method of embodiment 75, further comprising:
at the base station, receiving the user data from the UE.
   77. The method of embodiment 76, further comprising:
at the base station, initiating a transmission of the received user data to the host computer.

### REFERENCES

1. TS 38.423 v. 16.5.0
2. TS 38.473 v. 16.5.0
3. TS 38.401 v. 16.5.0

1-50. (canceled)

51. A method performed by a first node, the method being for handling migration of a node, the first node operating in a communications network, the method comprising:
sending an indication to a second node comprised in the communications network, the indication indicating a context of a third node, comprised in the communications network, to be migrated from the first node to the second node, the context being for control of radio resource, wherein a content of the indication is based on whether the migration of the third node is to be partial or full, and wherein the sending of the indication is performed in response to a first indication received from the second node, the first indication requesting the context of the third node from the first node.

52. The method according to claim 51, wherein at least one of:
with the proviso that the migration is to be partial, the indication further indicates one or more of:
i. one or more properties of ingress and egress BackHaul Radio Link Control (BH RLC) channels of the third node,
ii. a number of descendants of the third node,
iii. a respective address of the descendants of the third node,
iv. information on a topology of a branch of the communications network wherein the third node is located,
v. a first explicit indication that partial migration is requested, and
vi. a respective number and type of Internet Protocol (IP) addresses assigned to each of the descendants of the third node and the third node, and
with the proviso that the migration is to be full, the indication further indicates one or more of:
vii. the one or more properties of ingress and egress BH RLC channels of the third node,
viii. the number of descendants of the third node,
ix. the respective address the descendants of the third node,
x. the information on the topology of the branch of the communications network wherein the third node is located,
xi. a first respective context for control of radio resource for the descendants of the third node,
xii. respective one or more properties of ingress and egress BH RLC channels of the descendants of the third node,
xiii. a respective routing information for the descendants of the third node,
xiv. a respective number of descendants of the descendants of the third node,
xv. a respective number of parents of the descendants of the third node,
xvi. a respective number of devices served by the descendants of the third node,
xvii. a respective list of one or more first cells served by the descendants of the third node,
xviii. a second respective context for control of radio resource for the devices served directly or indirectly by the third node,
xix. one or more respective properties of radio bearers of the devices served directly or indirectly by the third node,
xx. respective information of one or more flows of the devices served directly or indirectly by the third node,
xxi. respective topology information for the devices served directly or indirectly by the third node,
xxii. a second explicit indication that full migration is requested, and
xxiii. respective Backhaul Adaptation Protocol (BAP) address, and/or a respective number and type of IP addresses assigned to each node to be migrated.

53. The method according to claim 51, wherein the context is a Radio Resource Control (RRC) context.

54. The method according to claim 51, further comprising:
determining whether the indication is to be for a partial migration or a full migration, and wherein the sent indication is based on a first result of the determination.

55. The method according to claim 54, wherein the determining is based on at least one of:
one or more measurements between the third node and one or more fourth nodes,
whether or not the third node is a mobile node,
a number of failures experienced by the third node with any parent node of the third node,
one or more indications received from the second node, and
a load of the first node.

56. The method according to claim 51, wherein the indication is a second indication and wherein the method further comprises:
receiving the first indication from the second node.

57. The method according to claim 51, wherein the indication is a second indication and wherein the method further comprises:
receiving a third indication from the second node, the third indication indicating whether or not the migration is accepted, wherein the receiving of the third indication is based on the sent second indication.

58. The method according to claim 57, further comprising:
determining whether or not to modify the migration based on the received third indication, and
repeating the sending of the indication, the receiving of the third indication, and the determining of whether or not to modify the migration, based a second result of the determination of whether or not to modify the migration.

59. The method according to claim 51, wherein the indication is a second indication, and
wherein the migration is to be partial, and wherein the method further comprises:
sending a fourth indication to the third node, the fourth indication indicating an F1 configuration update.

60. The method according to claim 51, wherein the communications network is an Integrated Access and Backhaul (IAB) network, and wherein the first node is a source Centralized Unit, CU, the second node is a target CU, and the third node is a top-level IAB node.

61. The method according to claim 51, wherein:
in partial migration, a mobile termination of the third node is to migrate to the second node, while F1 and Radio Resource Control (RRC) connections of its collocated Distributed Unit and all descendant mobile terminations and Distributed Units and devices served directly or indirectly by the third node, remain anchored at the first node, and
in full migration, all the F1 and RRC connections of the third node and all its descendants and devices served directly or indirectly by the third node, are to migrate to the second node.

62. A method performed by a second node, the method being for handling migration of a node, the second node operating in a communications network, the method comprising:
receiving an indication from a first node comprised in the communications network, the indication indicating a context of a third node, comprised in the communications network, to be migrated from the first node to the second node, the context being for control of radio resource, wherein a content of the indication is based on whether the migration of the third node is to be partial or full, and wherein the receiving of the indication is performed in response to a first indication sent by the second node, the first indication requesting the context of the third node from the first node.

63. The method according to claim 62, wherein at least one of:
with the proviso that the migration is to be partial, the indication further indicates one or more of:
xxiv. one or more properties of ingress and egress BackHaul Radio Link Control (BH RLC) channels of the third node,
xxv. a number of descendants of the third node,
xxvi. a respective address of the descendants of the third node,
xxvii. information on a topology of a branch of the communications network wherein the third node is located,
xxviii. a first explicit indication that partial migration is requested,
xxix. a respective number and type of Internet Protocol (IP) addresses assigned to each of the descendants of the third node and the third node, and
with the proviso that the migration is to be full, the indication further indicates one or more of:
xxx. the one or more properties of ingress and egress BH RLC channels of the third node,
xxxi. the number of descendants of the third node,
xxxii. the respective address the descendants of the third node,
xxxiii. the information on the topology of the branch of the communications network wherein the third node is located,
xxxiv. a first respective context for control of radio resource for the descendants of the third node,
xxxv. respective one or more properties of ingress and egress BH RLC channels of the descendants of the third node,
xxxvi. a respective routing information for the descendants of the third node,
xxxvii. a respective number of descendants of the descendants of the third node,
xxxviii. a respective number of parents of the descendants of the third node,
xxxix. a respective number of devices served by the descendants of the third node,
xl. a respective list of one or more first cells served by the descendants of the third node,
xli. a second respective context for control of radio resource for the devices served directly or indirectly by the third node,
xlii. one or more respective properties of radio bearers of the devices served directly or indirectly by the third node,
xliii. respective information of one or more flows of the devices served directly or indirectly by the third node,
xliv. respective topology information for the devices served directly or indirectly by the third node,
xlv. a second explicit indication that full migration is requested, and
xlvi. respective Backhaul Adaptation Protocol (BAP) address, and/or a respective number and type of IP addresses assigned to each node to be migrated.

64. The method according to claim 62, wherein the context is a Radio Resource Control (RRC) context.

65. The method according to claim 62, wherein the indication is a second indication and wherein the method further comprises:
sending the first indication to the first node.

66. The method according to claim 65, wherein the first indication further indicates whether or not the second node is able to accept a full migration or a partial migration.

67. The method according to claim 62, further comprising:
determining whether or not the migration is accepted, or whether or not to modify the migration, wherein the determining is based on the received indication.

68. The method according to claim 67, wherein the determining is based on at least one of:
a load of one or more of: the second node, one or more ancestors served by the second node, one or more second cells of the ancestors, one or more descendants of the third node, devices served directly or indirectly by the third node, and one or more third devices served by the descendants or the ancestors served by the second node, and
one or more quality of service, QoS, properties of one or more of: channels, bearers and priorities indicated in the received indication.

69. The method according to claim 67, wherein the indication is a second indication and wherein the method further comprises:
sending a third indication to the first node, the third indication indicating whether or not the migration is accepted, or whether or not to modify the migration, wherein the sending of the third indication is based on a third result of the determining.

70. The method according to claim 69, wherein the first indication is a UE Context Retrieve Request and the second indication is a UE Context Retrieve Response.

71. The method according to claim 69, wherein the indication is a second indication, and wherein the method further comprises:
repeating the receiving of the of the second indication, the determining of whether or not the migration is accepted, or whether or not to modify the migration, and the sending of the third indication, based on a third result of the determination of whether or not to modify the migration.

72. The method according to claim 67, wherein the indication is a second indication, and wherein, with the proviso that the migration is accepted, the method further comprises:
sending a fifth indication, wherein,
with the proviso that the migration is partial, the fifth indication is sent to the third node, and the fifth indication indicates:
i. information for radio resource control, and
with the proviso that the migration is full, the fifth indication indicates one or more of:
i. the information for radio resource control, and the fifth indication is sent to one or more of: the third node, one or more descendants of the third node, and devices served directly or indirectly by the third node, and
ii. an updated F1 configuration, and the fifth indication is sent to one or more of: the third node, and one or more descendants of the third node.

73. The method according to claim 62, wherein the communications network is an Integrated Access and Backhaul (IAB) network, and wherein the first node is a source Centralized Unit (CU), the second node is a target CU, and the third node is a top-level IAB node.

74. The method according to claim 62, wherein:
in partial migration, a mobile termination of the third node is to migrate to the second node, while F1 and Radio Resource Control (RRC) connections of its collocated Distributed Unit and all descendant mobile terminations and Distributed Units and devices served directly or indirectly by the third node, remain anchored at the first node, and
in full migration, all the F1 and RRC connections of the third node and all its descendants and devices served directly or indirectly by the third node, are to migrate to the second node.

75. A first node, for handling migration of a node, the first node being configured to operate in a communications network, the first node being further configured to:
send an indication to a second node configured to be comprised in the communications network, the indication being configured to indicate a context of a third node, configured to be comprised in the communications network, and configured to be migrated from the first node to the second node, the context being configured to be for control of radio resource, wherein a content of the indication is configured to be based on whether the migration of the third node is to be partial or full, and wherein the sending of the indication is configured to be performed in response to a first indication configured to be received from the second node, the first indication being configured to request the context of the third node from the first node.

76. A second node, for handling migration of a node, the second node being configured to operate in a communications network, the second node being further configured to:
receive an indication from a first node configured to be comprised in the communications network, the indication being configured to indicate a context of a third node, configured to be comprised in the communications network to be migrated from the first node, to the second node, the context being configured to be for control of radio resource, wherein a content of the indication is configured to be based on whether the migration of the third node is to be partial or full, and wherein the receiving of the indication is configured to be performed in response to a first indication configured to be sent by the second node, the first indication being configured to request the context of the third node from the first node.
